(19) United States
(12) Patent Application Publication
(10) Pub. No.: US 2013/0325736 A1
(43) Pub. Date: Dec. 5, 2013

(54) System For Selling

(71) Applicant: Jethro Bennett, Cambridge (GB)

(72) Inventor: Jethro Bennett, Cambridge (GB)

(21) Appl. No.: 13/906,321

(22) Filed: May 30, 2013

Related U.S. Application Data
(60) Provisional application No. 61/652,893, filed on May 30, 2012.

(51) Int. Cl. G06Q 30/02

(52) U.S. Cl. CPC G06Q 30/0279
USPC 705/329

(57) ABSTRACT

A system for selling comprises allowing an item 10 to be purchased by a user, allowing at least one cause to be associated with the item, providing a dispersement indicator 12 to indicate to a user that purchasing of the item liberates a dispersement to at least one cause, and dispersing the dispersement to the at least one cause when the item 10 is purchased by the user. Preferably there is provided a user account for the user which may allow dispersement information to be viewed by the user. Preferably dispersement settings are alterable by the user. Preferably there is provided a link protocol so that user and cause can be linked when a dispersement is made by user to cause. In an alternative embodiment, spontaneous cause creation may be facilitated via the system, with users able to push a cause, dispersing to the cause via otherwise unrelated purchases.

### CROSS REFERENCE TO RELATED APPLICATIONS

The present applicant claims benefit of priority to U.S. application US61652893, filed May 30, 2012.

### COPYRIGHT

The present applicant claims copyright of all written and drawn matter in the present application, including unique terms utilised.

### DEFINITION OF TERMS

Term: ‘entity’ is used to describe any of a person, a group of people, a company or any other element of any type. Term is intended to be broad and in no way limit scope of the invention.

Term: ‘seller’ may be a vendor, a manufacturer, both, or any other seller.

### BACKGROUND

There are two significant problems with political and economic systems in the West, though not limited to the West, and particularly with present democracies.

A first problem is that democracies (and many other political systems) are prone to a rise and fall, peak and trough pattern.

One of the reasons for this is that ‘growth’ is seen as king in western democracies. If an economy is in ‘growth’ it is said to be healthy. In reality growth is often a precursor for recession, especially where the growth is
1) Excessive
2) Not based upon firm foundation.

Driven often by greed in some sectors, and by need or thirst to secure votes in other sectors, an economy may be driven toward excessive or high growth.

Typically, in such times of high growth, politicians believe and/or state that they are doing excellently in terms of economic health and prosperity.

In countries such as the United Kingdom, the United States, and others, previous to the economic crash of 2008, politicians believed they were doing positively since economies had been experiencing significant growth trends for some time.

In reality, the economy was set up for recession because the growth was either excessive, or not based on correct and/or firm foundation. Money had been borrowed excessively.

A universal rule is that what goes up must come down—if growth is not based upon sure and real foundation, it is destined not only to fall, but to come crashing down. Such a crash was experienced in the economic crash of 2008.

But this trend of rise and fall; growth and recession has been going on for some time. Most major western democracies have experienced, over the last 20-30 years, at least 2 or 3 rise and fall trends, with growth, followed by recession. No solution has been found.

The poor (or non-wealthy) suffer most during recession; a billion dollar company (or billionaire) may individually lose more money (such as 500 Million dollars, for example), but a billionaire (or corporation) losing 500 Million dollars still leaves the billionaire with 500 Million dollars or more, and little in the way of lifestyle change.

However, if a poor (or non-wealthy) person loses 50% of what they have, they may (or will) struggle to eat correctly, may have to take on more work, and during such economic crises, workers tend to lose their jobs.

Thus it can be seen that the poor pay a heaviest cost during a recession, and that western economies continue to rise and fall at expense, for the most part, to the non-wealthy.

A second problem is that modern western democracies, whilst they pride themselves on being described as democracies, could be argued to be running an outdated version of democracy, and that, furthermore, democracy does not define a modern western culture; Capitalism is at an epicentre of modern western culture.

A democracy is often thought to be defined as a country where voters freely vote for a leader. This is a weak understanding; democracy does not mean voting for the people (although that is a crucial element of a democracy; democracy means power to the people. (That the people rule)

Democracy originated in Athens, Ancient Greece more than 2000 years ago. At the time, it was considered radical, mad, and perhaps even dangerous by other provinces of Greece. But it was not the voting that was considered radical, it was the fact that it was a new system, where, as defined by Aristotle, “the poor rule the rich”.

The democracy in Athens was arguably more radical than our democracy today. There was more voting, on a far more regular basis, and regular public meeting where ‘the poor’ could take part and have their say. To define what a democracy is, Aristotle states:

“Democracy is when those who do not own much property, but are poor, have authority in the system of government”,

An uneasy fact is that it is very possible that a scholar from time of origin of democracy may not consider what we have in modern western countries as democracy. We have freedom, but not power. The poor do not govern. The poor are subject to decision by others.

The reality is that democracy has become a carrier; a carrier for a powerful economic doctrine, and one that, in some part, has served the economy well: Capitalism.

Capitalism defines our every day far more so that democracy. Commentators may state that it is democracy that gives us our freedom. However, that is wrong. The present weak understanding of democracy is that it is defined, for the most part, as a nation that votes for its leader. Democracy though, is not only about freedom (which is an element of democracy), it is about power, and that the poor (non-wealthy) have the most power because, as one individual, they may not be as influential, fancied, powerful, etc, but as a whole, they are more powerful. This is not simply in terms of ability to vote.

The question must be asked—are the poor powerful? Do the poor have the resources to rule? If not, this is not a democracy. If the poor feel disempowered, democracy is not vibrant. If democracy is vibrant, the poor are empowered more than any other. (This is the opposite of recession, where the poor are disempowered more than any other).

In a sense, it could be said that democracy, at present time, simply facilitates Capitalism.

### SUMMARY

The present invention seeks to provide a solution to both problems: the rise and fall, growth and recession trend of the economies, and the problem that democracy no longer defines everyday life, and has, for the most part, become a carrier for Capitalism, by providing, according to a first aspect of the invention, a system for selling, comprising: allowing an item to be purchased by a user; providing a dispersement indicator to indicate to the user that purchase of the item liberates a dispersement amount for dispersement to at least one cause; dispersing the dispersement amount to the at least one cause. Preferably there is provided a dispersement amount indicator for indicating to a user amount that is dispersed when item is purchased.

There may be provided a cause dispersement indicator so that it is indicated to a user what cause(s) is dispersed to when item is purchased.

In a preferred embodiment, there may be provided a user account for the user, to which dispersement details are relayed, so that user may view dispersement amounts, details, and information within their account, which is still more preferably password protected.

The system may allow a payment method to be integrated so that a user can attach, for example, a bank account to user's user account, which facilitates relaying of dispersement information to user account when purchase is made via the, for example, bank account. The system may incorporate its own payment method and/or system.

In a preferred embodiment, for some items, user may be given a choice of dispersement causes. It is feasible dispersement choice may be made after purchase, via user account.

The system may allow an entity to create a cause, and may relay information to the cause regarding dispersement information via a cause account. Bank details or the like may be required from a cause in order to facilitate dispersement to the cause.

The system creates an interactive element to buying whereby a dispersement amount is liberated when an item is purchased.

Sellers may be provided with an account within which they may be allowed to choose cause(s) to associate with items for selling.

According to a second aspect of the invention, there is provided a system for selling, comprising: allowing a user to purchase an item; allowing a plurality of causes to be associated with the item, so that when the item is purchased by the user, a dispersement amount is dispersable to at least one of the causes; providing cause choice for the user, wherein cause choice for the user is choosable at least one of: before purchase via a smart device; substantially during purchase; after purchase via a user account.

It is feasible an interlocuting element, such as a scannable card, is required in order to facilitate relaying of dispersement information to user account, or to facilitate dispersement to a cause.

For any aspect of the system, user dispersement settings may be alterable by the user through user account, or by other means.

According to a third aspect of the invention, there is provided a system for financing, comprising: allowing an entity to create a cause; allowing the entity to display a dispersement indicator; allowing a user to connect with the cause via smart device; providing a PUSH protocol so that the cause can be pushed by the user; altering settings of the user so that the cause is pushed by the user, settings thus altered to bias user dispersement to the cause. In such an embodiment, an aspect of the invention may be used even when a purchase has not been made. A user may connect with a cause (preferably via a smart device) which may connect via a connecting facilitating element, such as a scannable code. User is provided with option to PUSH a cause, which creates a bias in user settings to disperse to the cause. Future purchases by the user may now incur dispersement to the cause, even if the cause is not associated with purchase of the item. PUSH functionality may be usable in any embodiment of the invention.

Sinilarly, there may be provided a LINK option, whereby a user, preferably only when a cause has been dispersed to by the user, may allow a LINK to be formed between user and cause. This may facilitate cause in sending information to user, such as updates, for example, when a milestone has been reached due to dispersement amount.

The present invention will now be more particularly described, with reference to the accompanying drawings, by way of example only and in no way limiting the scope of the invention, in which

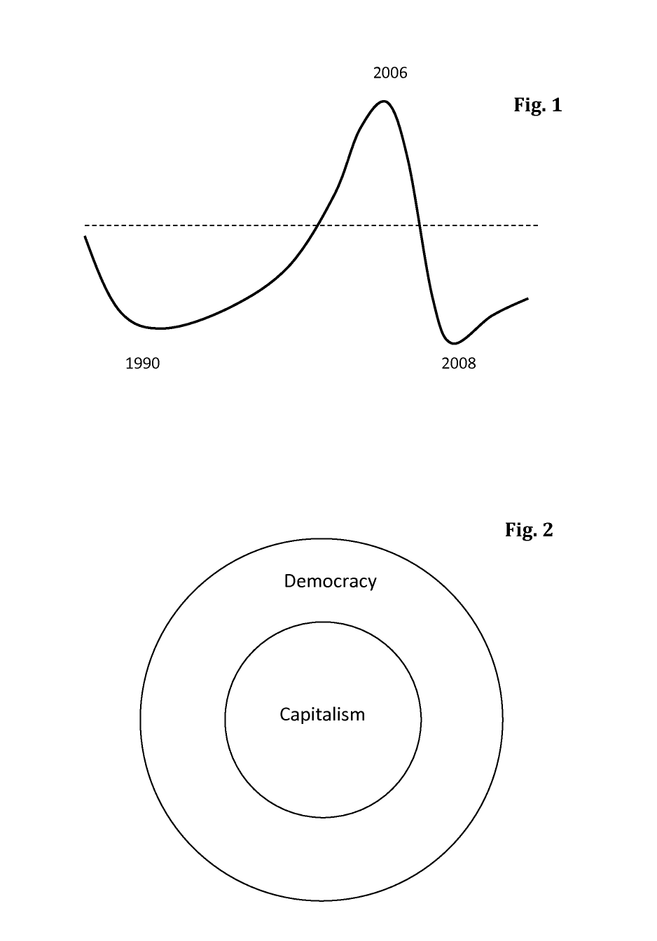

FIG. 1 is a simplified graph (for representational purposes) of a rise and fall, growth and recession trend of a United Kingdom economy over 20 years;

FIG. 2 is a diagram representing democracy as a carrier for Capitalism, showing Capitalism plays a central role;

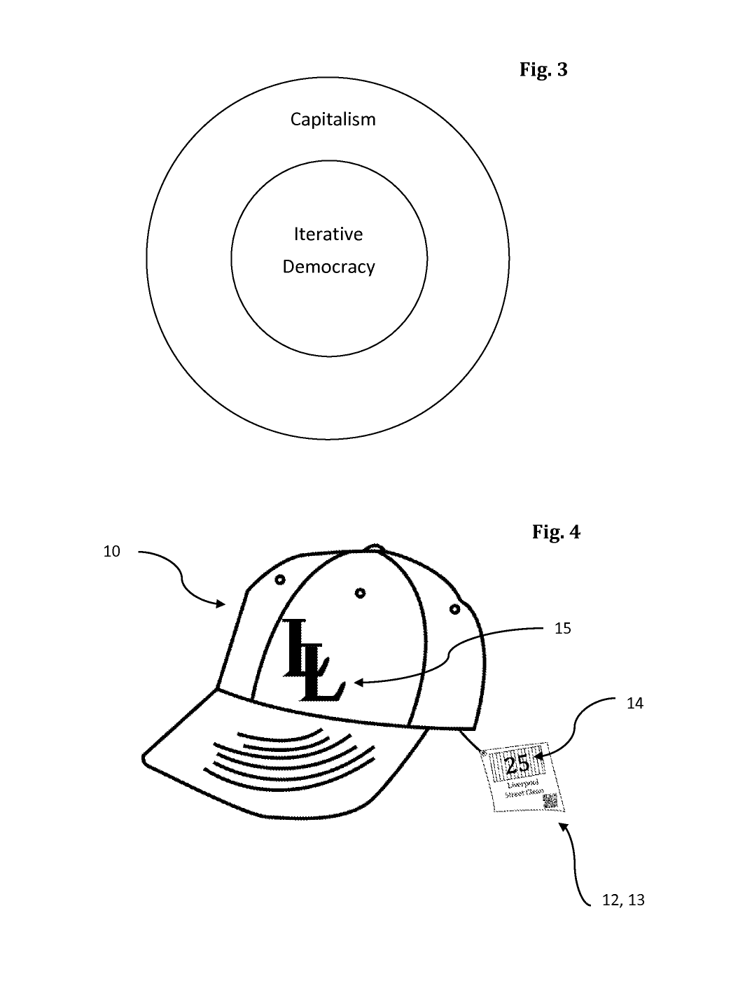

FIG. 3 is a similar diagram where the present invention is in use, where democracy again plays a central role in a life of a citizen; roles are reversed and Capitalism becomes a carrier for democracy;

FIG. 4 is an example of an item for sale where there is provided a dispersement indicator and information, indicating to a user that purchasing of the item liberates a dispersement amount;

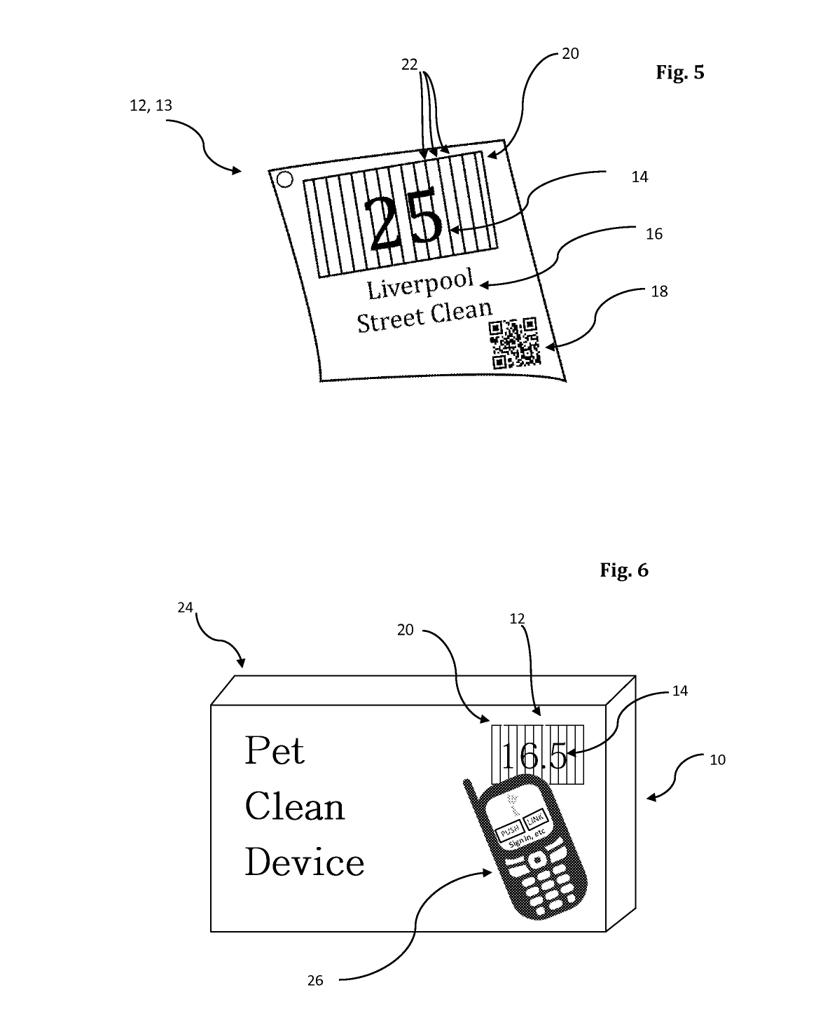

FIG. 5 is a close-up view of the embodiment of a dispersement indicator which incorporates a dispersement amount indicator and a named dispersement cause;

FIG. 6 is an example of a different item for sale where dispersement information and/or connection can be accessed by a user via a smart device;

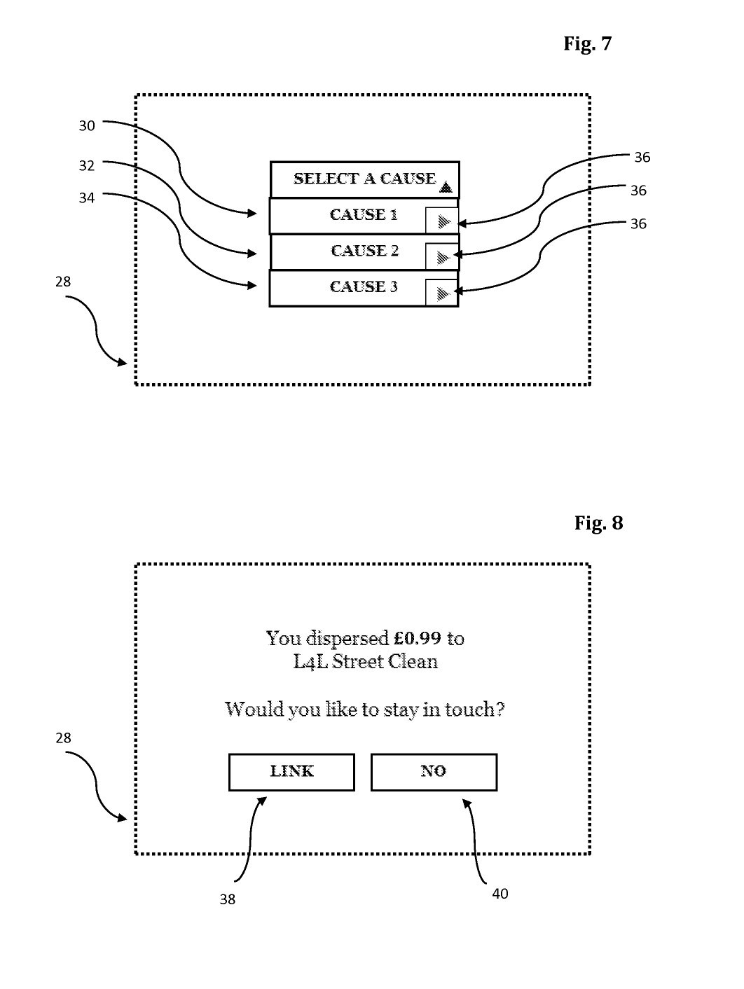

FIG. 7 is a dispersement cause selection screen which may be shown on a computer device and the like;

FIG. 8 is a LINK screen, which provides facility for user to LINK with a cause;

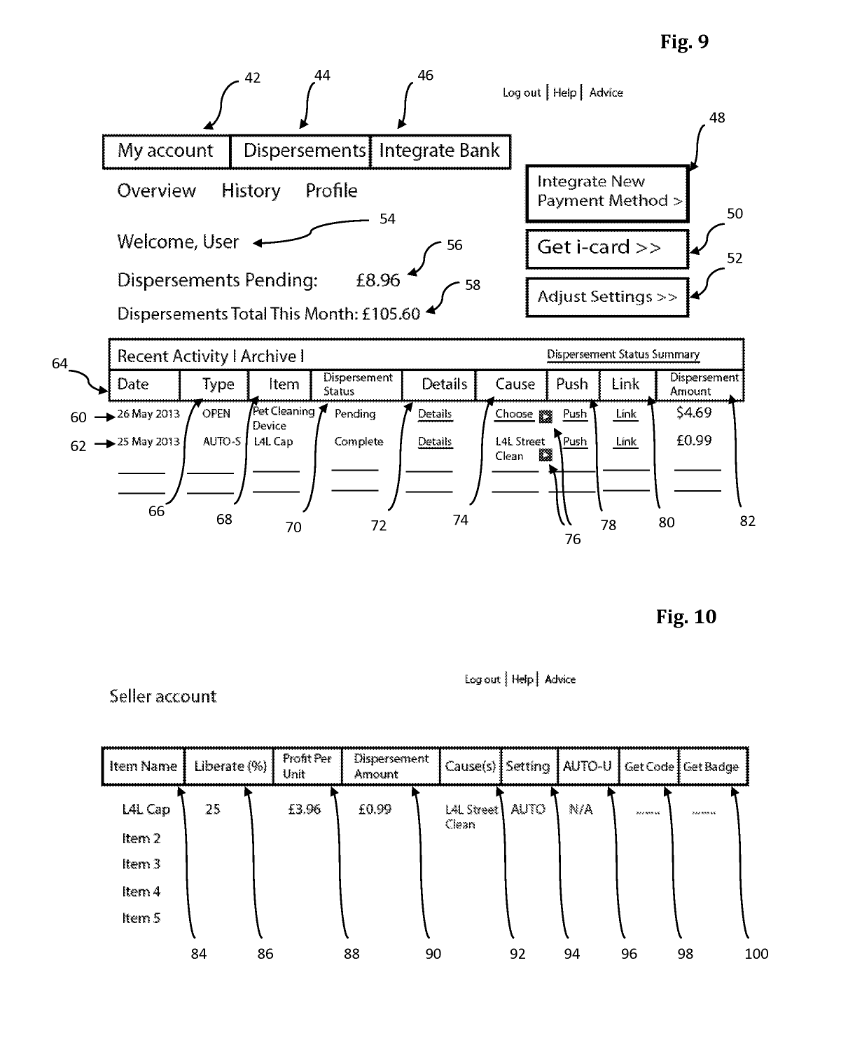

FIG. 9 shows an embodiment of a user account homepage where dispersement information may be provided to the user;

FIG. 10 shows a basic embodiment of a seller page, where seller may be provided with tools to set dispersement choices and parameters for users;

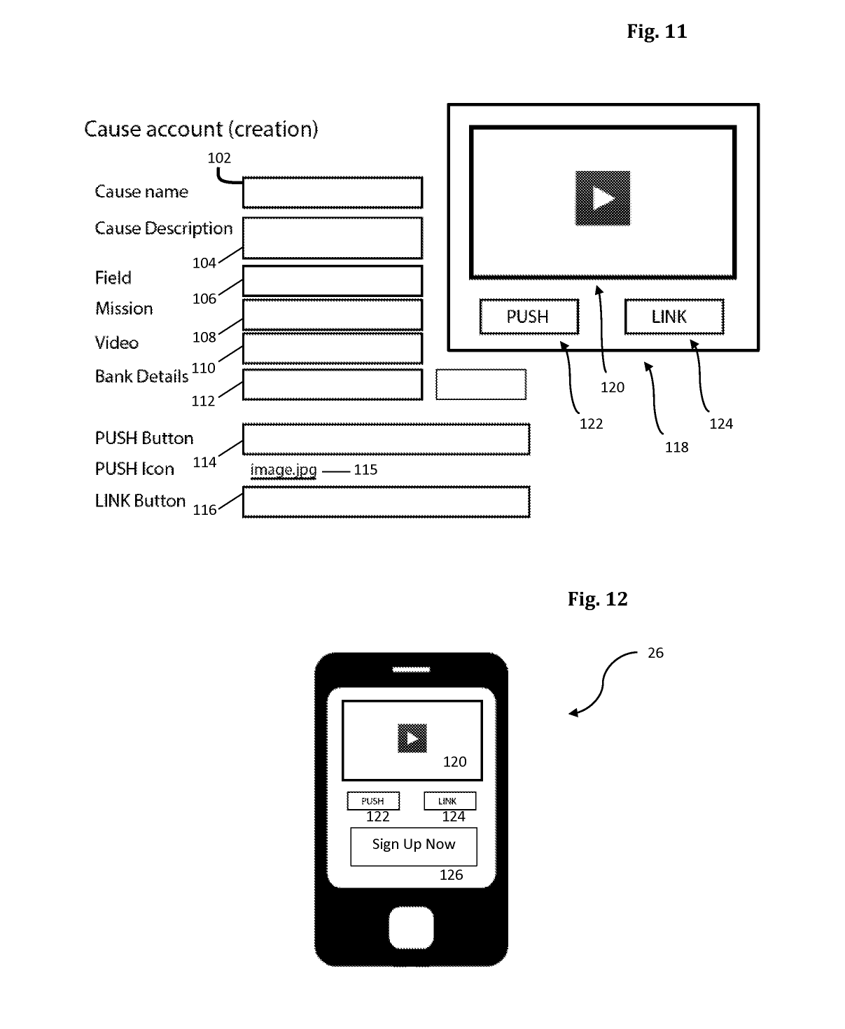

FIG. 11 shows an example (and basic) embodiment of a cause page, where a cause for dispersement may be created by a user and/or entity of any sort;

FIG. 12 is a front view of a smart device which has connected with a cause, most preferably for pushing the cause;

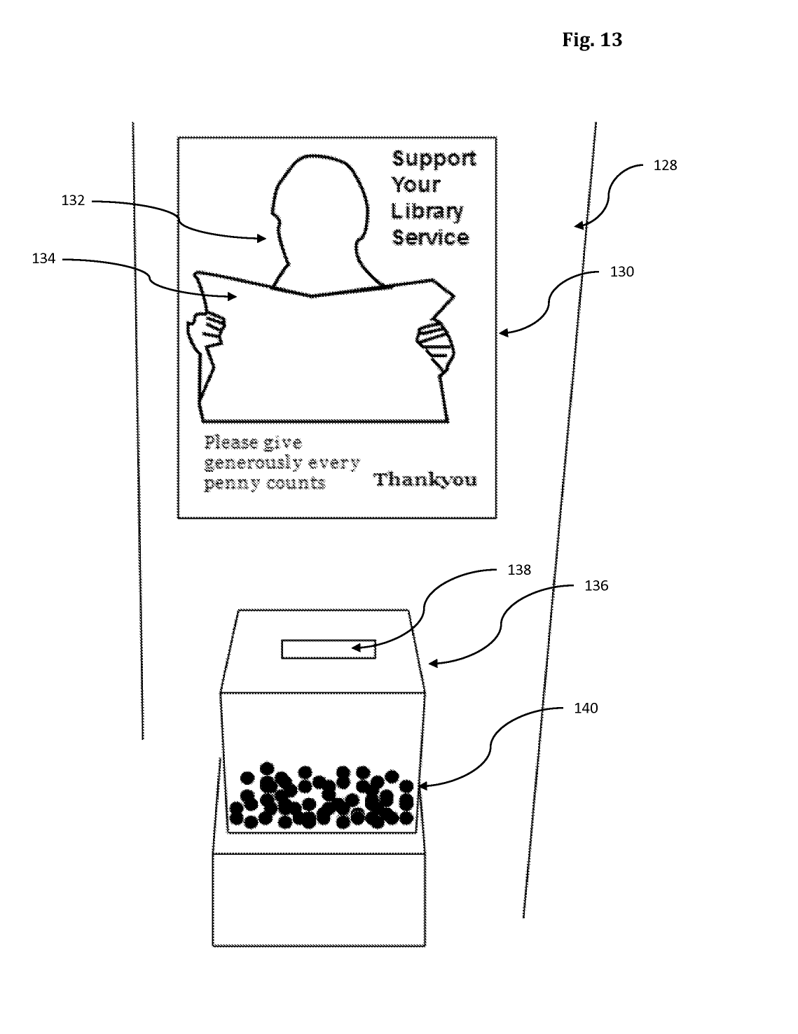

FIG. 13 is an example of an attempt to create financing for a library using traditional methods and not using the present invention;

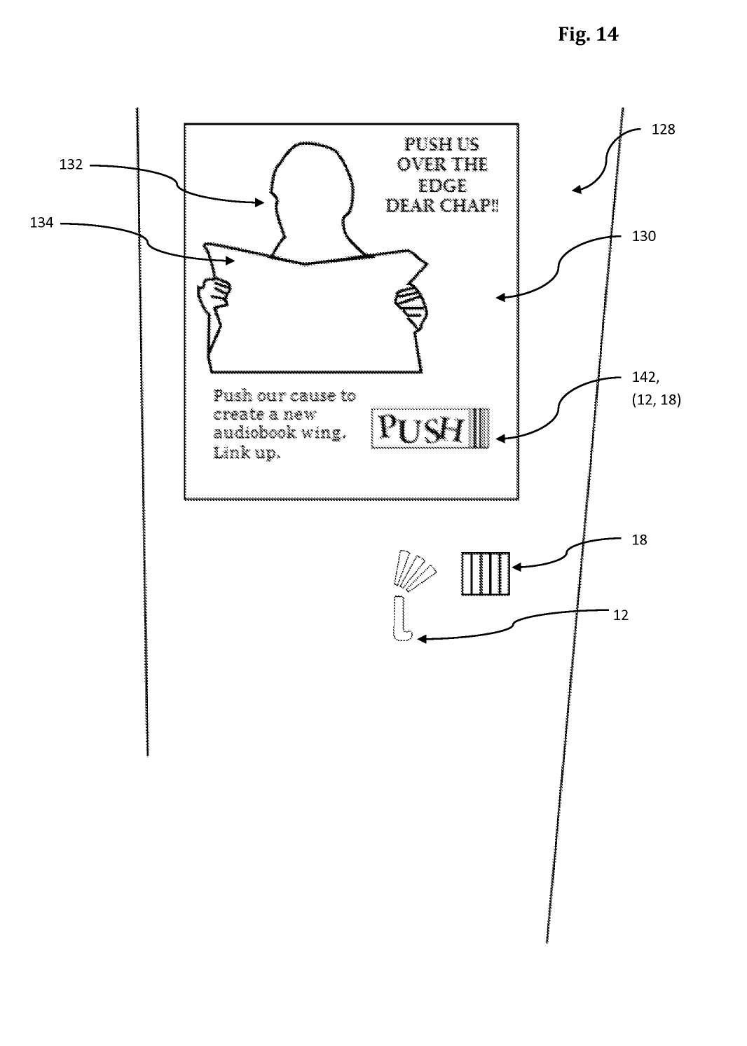

FIG. 14 is the financing attempt as shown in FIG. 13, wherein, rather than traditional methods, the present invention is used;

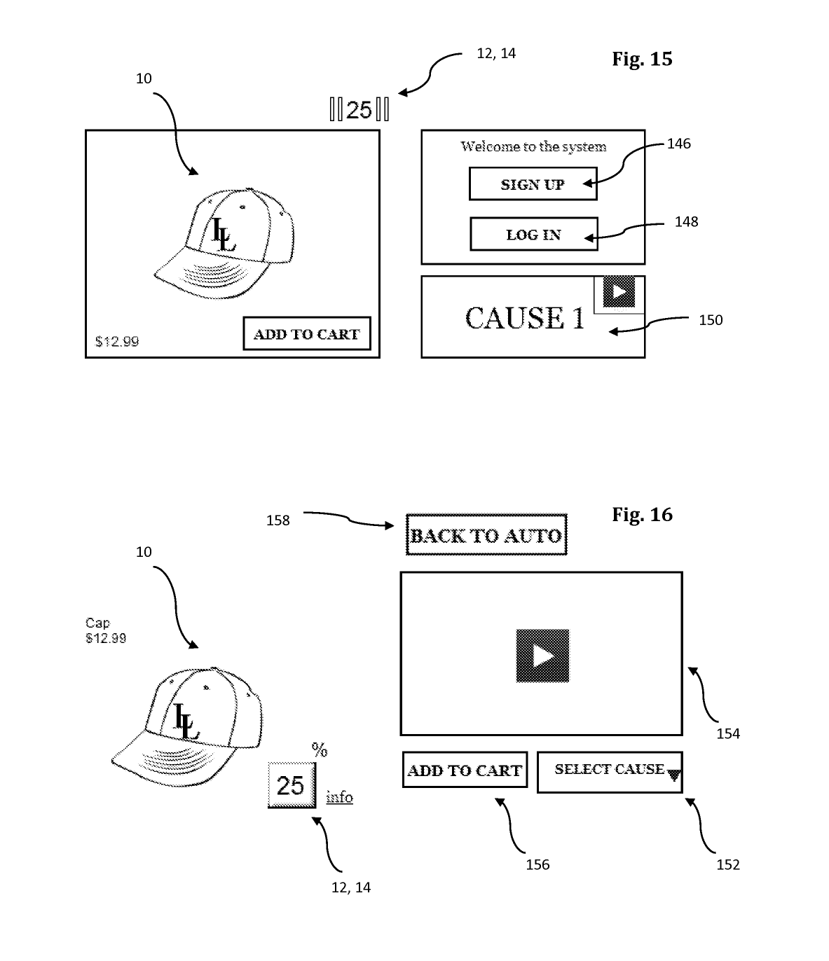

FIG. 15 is an example of the invention used to sell an item on a website; and

FIG. 16 is an example of the invention used to sell an item of the website where a user has logged in and is using user settings.

### DETAILED DESCRIPTION

Referring to the drawings, there is shown in FIG. 1 a simplistic peak and trough graph of a British economy, (used for representational purposes), displaying a recession in the early 1990's, an excessive growth period in the mid 2000's period, and a second crash/recession of 2008. Thus a pattern can be seen of a relationship between growth and recession, and more particularly, excessive growth and recession.

In FIG. 2, there is shown a circular diagram that represents a socio-political nature of a western society, where, whilst loosely translated as being a democracy, in truth, democracy is a carrier for Capitalism, where Capitalism plays a central role in society, and democracy, whilst nonetheless being a defining factor, is on a periphery. As aforementioned, this causes problems and may be a leading factor in a pattern of rise-and-fall, growth and recession.

In FIG. 3, there is shown a similar diagram, where the present invention is utilised. Thus democracy (termed here ‘Iterative Democracy’ as it is at the epicentre of life, both for the one, and for the all), again plays a central role in a life of a citizen.

Roles are reversed—Capitalism is ‘used’ or ‘harnessed’ and becomes a carrier for democracy, rather than democracy being a carrier for Capitalism.

Whilst not replacing ‘voting’, dispersing of liberated amounts will be shown to be a form of democracy where the poor (non-wealthy) are powerful. This may be more representative of democracy in a Capitalist age, and more empowering.

Because there are greater numbers of the poor, it will be shown, the poor, in a sense, govern.

Due to the unusual (and abstract) nature of the invention, it is thought a best way to demonstrate the invention is with particular examples.

The invention may be particularly of use (although it is not limited to use) with cities of significant, but not excessively large, size. For example, there are cities, such as London, Rome, etc that may have many millions of inhabitants. Whilst this gives tremendous scope for the present invention, in smaller (but still significantly sized) cities, there may be a communal spirit which is less evident in larger communities.

For example, a city such as Liverpool, England, has a population of 440,000. At almost half a million, inhabitants, it is significantly sized (which is useful for the present invention), yet, in part because it is not excessively sized, there is a community spirit within its citizens which may be less evident in some larger cities (or countries for example). Nevertheless, the present invention (which is a system for selling and dispersing), may be used in any community of any size, whether that be a town, city, area, country, group, etc, and may be used in extremely large cities, countries, or on a global level.

Thus there will be shown an example of the invention in use in a city such as Liverpool, England. For the present example, the invention is shown when used for selling an item in a physical location, such as a shop and the like.

‘AUTO’ Setting

There is shown in FIG. 4 a purchasable item 10, (which is here a baseball cap but may be any item, product, element for sale, etc) that liberates a dispersement when purchased. There is shown a tag 13 attached to the cap 10, which is a dispersement indicator 12, since it indicates to a user that the item liberates a dispersement when purchased. The dispersement indicator 12 incorporates a dispersement amount indicator 14 that indicates a dispersement amount for when the item is purchased.

A dispersement indicator 12 is an indicator that indicates purchasing of an item liberates an amount for dispersement. A dispersement indicator 12 may simply be an icon, logo, symbol, etc if the symbol, for example, is recognisable to a user and indicates to a user that purchase of an item liberates a dispersement. Thus, the dispersement indicator may, for example, simply be signage outside of a shop, indicating to a user that purchasing of an item(s) inside the shop liberates a dispersement. Preferably the indicator incorporates a dispersement amount indicator 14, thus providing further dispersement information to the user.

An indicator 12 may be provided on the item 10, or, for example, on a rack of a shop, or anywhere that is intended to provide dispersement information to a user about the item 10. (If the item 10 is sold via a website and the like (shown on a computer screen), an indicator 12 may simply be an indicating element appearing anywhere in proximity to the item 10). A dispersement indicator 12 need not be a number and may simply be a symbol. Purpose of the dispersement indicator 12 is to at least denote to a user that purchasing of the item liberates a dispersement. Preferably, the dispersement indicator also indicates to a user amount of dispersement liberated by purchasing the item 10.

It is feasible there are multiple separate indicating elements. (For indication that purchasing of an item liberates a dispersement; for indicating amount liberated by purchasing the item; and feasibly also for indicating cause or causes liberated amount is dispersed to by purchasing). Nevertheless, such multiple indicating elements can be said to be incorporating elements of a multi-partheid dispersement indicator. As stated, it is feasible that the dispersement indicator 12 is simply a symbol, if the symbol is recognisable to a user as indicating that purchasing of the item liberates a dispersement.

There is shown a logo 15 on the item 10. Branding may be of particular importance in a range of purchasable items that incur dispersements about a given community when purchased within a particular community. A brand logo, name, etc, if it becomes recognisable to a user as a brand that uses the present system, may itself be a dispersement indicator 12, since it indicates to a user that purchasing of the item liberates a dispersement.

The indicator 12 (which is here a tag 13) can be seen more clearly in FIG. 5, where it is shown in close view. There is clearly shown a dispersement amount indicator 14 on the tag 13, which, in the example (which is also a preferred) embodiment, is a percentage amount that indicates that 25% of all profit generated from sale of the item 10 is liberated for dispersement when the item 10 is sold. (The percentage sign is not shown as it is thought that if use of percentages as a dispersement amount indicator is used widely for the present invention (which is a system for selling), it will be understood by users that a ‘25’ indicates that 25% of profit generated from selling of the item is liberated for dispersement). In a preferred embodiment, the percentage amount indicates to a user that 25% of all profit generated from selling of the baseball cap is liberated for dispersement when the cap is purchased. However, it is feasible amount liberated on sale of the item 10 may be provided by other means, such as a total amount etc. Thus the dispersement amount indicator 14 may be a lump sum, rather than a percentage.

In a preferred embodiment, as shown, item is labelled with the indicator 12. However, if a large amount of, for example, caps are placed on a shelf of a shop for selling, it is feasible there may be provided an indicator for the whole rack, rather than each individual item. Thus the indicator is not limited to being on or attached to the item. Similarly a whole shop may have a standard dispersement figure for all items. Thus if all items sold in a shop liberate 25% of profit for dispersement when purchased, the shop may simply use signage, for example outside of the shop, to indicate such a fact, the items themselves not being tagged with indicators. Thus signage in the said example, even though it is not placed directly on or about the item 10, is a dispersement indicator 12. Anything that indicates dispersement information to a user is a dispersement indicator 12. A dispersement indicator may feasibly be digital, or shown by digital and/or electronic means. In another example, writing on a blackboard may be a dispersement indicator 12 if it indicates dispersement information and/or values to a user.

Thus, for the present example, if the baseball cap sells for £6.99, and the cost price for selling the item (which may include a plurality of factors, such as cost of materials, cost of manufacture, cost of delivery, and may also include further dynamic costs, such as staff wages, rent paid on shop property (if the item is sold at a shop), etc) is £3.03, then the profit generated from selling the item is £3.96.

(It will be obvious to those with skill in the art that if factors such as wages, rent, etc and all costs are calculated as part of a total cost price of the item, there is significant scope for error and/or over-calculation of true cost price. Preferably there is provided an industry-wide standard for how to calculate cost price (or true cost price) of an item in order to deter improper calculating of cost price of an item(s)).

Thus, as stated, if the sales price of the cap is £6.99, and the cost price is £3.03, £3.96 is generated from selling of the cap, and if (as in the present example), 25% of the profit generated from selling the item is liberated when the item is sold, then £0.99 (or 99 pence) is liberated for dispersement when the item is sold.

As shown on the tag in FIG. 5, there is also shown a dispersement cause 16 that the dispersement amount is dispersed to. In the present case, the cause is noted as ‘Liverpool Street Clean’. This indicates to a user that the dispersement amount (99 pence) is dispersed to help clean the streets of Liverpool when the baseball cap is purchased.

It is also feasible that the dispersement amount is indicated as a lump sum, such as simply denoting ‘99 p’. However, if pricing of the baseball cap changes, the said amount may prove incorrect. A percentage indicator is preferred. Feasibly both may be provided.

A dispersement indicator 12 may also be provided inside the cap, or incorporated unto the cap in some way (such as sewn in, etc). A dispersement indicator may simply be writing or text since any dispersement information indicated to a user is a dispersement indicator 12.

The dispersement amount indicator 14 (here 25%) is shown as part of an icon 20 (which is not essential). The icon 20 is intended to be recognisable to a user and depicts bars 22 that are imprisoning the dispersement indicator amount 14. This indicates to a user that, in the present example, 25% of the profit of the item is imprisoned, and can be liberated by purchasing the item 10. In alternative embodiments of such an icon 20, there may be shown an imprisoned stick-type character, with the ‘25’ number emblazoned on the character. Such an icon may be important since a number (such as ‘25’), in and of itself, is not particularly outstanding to a user, since tags on items for sale, or signage in shops, or websites, often include numbers (such as a price tag).

(The icon may bouble up as a scannable element, either for shop keeping, or user (buyer), which may be used as part of a shop price keeping system, or may be used for a user to connect with via smart device to extract further dispersement information about the item).

Thus a recognisable icon 20 to denote liberation amount may be important for recognisability to a user. The tag 13 may include other information such as price of item, definite dispersement amount, etc.

There is also shown on the tag 13 an optional feature of a scannable code or icon 18. It is feasible the code 18 can be scanned by a user, such as, for example, by a smart phone or smart device of a user, which may provide information to the user about dispersement. For example, there may be shown added information, such as an image, message, logo, or video about the cause to which the liberation is dispersed. Intent of the scannable icon 18 is that a user can gain information about any of: the item, dispersement amount, dispersement cause, etc. Such a code/icon 18 may itself be deemed to be (and therefore be) a dispersement indicator 12, as it feasibly may incorporate any or all of the dispersement information as seen on the tag 13, and thus may be used to indicate to a user that purchase of the item liberates a dispersement, especially if the code/icon 18 is recognisable to a user as indicating that purchase of the item liberates a dispersement.

Such technology is well known to those with skill in the art. A QR-code (or the like) may be provided. Thus a user may be directed to, for example, a website with added information about the dispersement cause via a, for example, smart device. Since a video or any other information, such as an image, etc can easily be uploaded to a website (thereby gaining a URL), it would be easy for a video, image, etc to be displayed to a user when they use the scannable code.

It will be obvious to those with skill in the art that present technology allows connection with a smart device in this way without necessarily requiring ‘scanning’. Thus term ‘scanning’ is used in a broad sense to denote that a change is initiated on the smart device, providing further information to a user as aforedescibed, the term ‘scannable’ in no way limiting a scope of the invention).

A benefit of such codes is that they can be dynamic—they are alterable. Thus if a seller of the item (who may be a brand manufacturer of the item or a vendor, or both), may be allowed to alter dispersement information (such as dispersement amount 14 and/or dispersement cause(s) 16 to disperse to), without the item 10 or indicator 12 having to be re-labelled. This is especially useful if the code 18 is configured to relay user to a webpage and the like.

The term ‘scannable’ is here used broadly since it is feasible future technologies will not require ‘scanning’ of a code, and may use proximity or any other method to display information to a user. The term ‘scannable’ is used broadly and incorporates any means by which information can be provided to the user via a smart device and the like, from the item and/or tag, or from any other means.

When the item is purchased, 25% of the profit is dispersed to the cause 16 of keeping the streets of Liverpool clean.

Preferably both dispersement amount indicator 14 and dispersement cause 16 information is provided to the user.

This is an example of the invention in a basic embodiment, where the system for selling is used in an automated (‘AUTO’) manner—such that the dispersement is predetermined to go to a pre-determined cause before the purchase is made. (No choice for the user).

In such an embodiment, no account is necessarily needed for the user—they may simply purchase the item 10 as normal and dispersement of the liberated amount may be carried out by the seller (e.g. the shop) or the system (provider) or both. Since there may be two sellers (manufacturer of the item 10 who sells wholesale to the vendor, and the vendor themselves), both may be termed a ‘seller’. The vendor may implement (or be provided with) systems that acknowledge sale of the item, and accordingly denote the sale within a system, so that it is acknowledged that the item 10 has been sold and a dispersement amount has been liberated.

Thus it can be seen that, if a whole range of, for example, clothing was provided to a user for sale, cause(s) 16 for dispersement could be pre-determined for each item 10. Similarly dispersement amounts 14 could also be predetermined, so that, for example, whilst 25% of profit from sale of the baseball cap 10 is liberated on purchase, 50%, for example, of profit generated from sale of a shirt 10 may be liberated, and the cause 16 may be different. As will be shown, a seller may feasibly be provided with a seller account and/or interface to choose and decide such dispersement information.

In such a way, a range of clothing dedicated to (and branded for) a community, can be sold to the community, thus resultant in liberated amounts being dispersed about the community. This, in effect, puts political and economic power in the hands of the people. Whilst a rich person may spend more, and therefore may feasibly, individually, liberate more dispersements, the poor (or non-wealthy) are more numerous by far. Therefore the non-wealthy have more power with the present system since, in number, the amount liberated for dispersement by the non-wealthy will far outweigh the amount liberated for dispersement by the rich.

Since, even in a recession, vast amounts of money are spent on clothing, an interesting effect of the system (and such a, for example, clothing range), is that it may substantially (or wholly) immunise a community from recession, since it ensures vast amounts of dispersements are dispersed about a community.

Thus even in times which would today be called recession, many millions of items (or far more) of clothing may be sold and purchased each year in such a community. Thus vast amounts of dispersements may be liberated, which may be used to invigorate the community, finance new projects, buildings, etc.

Whilst the system may be suited to selling clothing items, it is in no way limited and may be used for selling any item, product, etc.

Usually (without the present invention), profit from a sale of a, for example, item of clothing, goes to the seller or to the seller and brand manufacturer of the clothing.

With the present invention, much of the profit is dispersed back into the community.

The system also has an ability to evolve—as it is seen what is required to help, create, grow the community, liberated amounts may be dispersed into according areas. The system may also intelligently disperse in this way, recognising areas where dispersement is required and dispersing to such areas accordingly.

Furthermore, in a case of a disaster, or problem that hits a community—for example a cyclone, typhoon, earthquake, etc, the system can easily be altered so that all, or a part of, dispersements can be dispersed to a cause (or bank account) for help with the disaster, problem etc. (This may use similar or the same protocol(s) as a ‘PUSH’ protocol for the system which will be demonstrated proceedingly). As will be shown, either the seller, and/or the provider may be able to alter settings for the system in such a way, or to alter the system to allow users to alter settings to ‘PUSH’ liberation amounts to a cause.

The system is not limited for use with a clothing range, and may feasibly be used with an array of items for sale, such as cutlery, mugs; any retails items under the Sun. It may be used for selling of non-physical items, such as digital programs. Anything for sale is deemed to be a ‘product’. The present invention may be used to sell any product.

Nevertheless, the present invention (system for selling) may be particularly useful for use with selling clothing. In such a situation, a noticeable brand may be set up for recognition by a community.

It is feasible users in one community may be able to buy items that incur a dispersement to a different community, group, and/or area. (It is also feasible that such action may be limited or blocked either partially, or wholly by the present system).

In such an example as shown in FIG. 4 and FIG. 5, where a baseball cap 10 is sold and a 25% of profit generated from selling the item 10 is liberated and dispersed to a cause 16 (street cleaning), a system is required for dispersing the liberated amount to the cause(s) 16. In a basic embodiment, this can be achieved by the cause 16 having a bank account, which bank account details are received by and incorporated into the system, so that liberated amount(s) can be dispersed into bank account of the cause 16. This may be done with substantially immediate effect, or may be done, for example, at the end of a month or period of time.

A card (or the like) may be required by a user to allow dispersement and/or to relay dispersement information to a user account and/or cause and/or seller account. Such a card (or the like) may be termed an interlocuting element, since it is facilitates flow of information between a purchase (or the purchase vendor system) and the present system for selling. Interlocution means communication between.

If there is integration with a particular bank account, for example or a method of payment is used that is incorporated as part of the system, then an interlocuting element may not be required. If this is not the case, if purchases of items 10 that liberate dispersement are made at a vendor, it is feasible, once items have been scanned and processed through a till, a card (interlocuting element) or the like may be required to be scanned in order for dispersement information to be transferred from vendor to the present system. A card is given by way of example and any such interlocuting element may be used, An interlocuting element may not require scanning for use. An interlocuting element may be scanned (and the like) before, after or during purchase. It may facilitate dispersement and/or relaying of dispersement information.

In the example as set forth, the provider of the system may also be the seller, so that the proprietor of the present system (and technology) for selling also makes, designs, manufactures and sells the item. However, it is also feasible, for another example, that the provider provides the system for use by a seller. The seller may be a brand manufacturer of the item, or may be a vendor, or may be both, (or any other seller).

Thus there may be four party elements involved in transaction process using the present system: Provider (provider/proprietor of the system for selling itself), Seller (who may be a brand manufacturer, or vendor, or both, or any other seller), User (who purchases an item 10), and Cause (to whom a liberated amount is dispersed when an item 10 sold using the system is sold). This will be described at greater length shortly, with reference to account creation.

In a case where the provider is not the seller, the seller may either be granted use of the system for selling, or may be provided with an account within the system, which may be set up with technology (such as, for example, but not limited to, software) to facilitate use of the system by the seller, which may, for example, facilitate setting up dispersement amounts for items, apportioning causes for items, linking bank account details of the causes to the items, etc, thus facilitating use of the system.

It is feasible fees may be incurred for use of the system, payable to provider.

Preferably, as will be seen, there is provided an account for a user, so that information of dispersements may be viewable by the user. This may require further information from the user be provided to the system, which will be shown.

Thus it can be seen, in the shown example, that the system can be used on an AUTO setting, where causes that liberated amounts are dispersed to is automatic, such that there is no choice for the user as to where the liberated amounts are dispersed to. This may be a most simple way to use the present invention.

It can also be seen (or understood) that in a community of 440,000, a vast amount of dispersements can be made. This is a form of democracy since it puts power in the hands of the people. Furthermore, it satisfies foundational definitions of democracy as, because the ‘poor’ of any community are more numerous than the rich, it gives power to the poor more than any other. In reality, the system does not differentiate between rich and poor, but due to numeration alone, it gives more power to the poor.

Still furthermore, the present invention reverses the roles of democracy and Capitalism, as shown in FIG. 2 and FIG. 3; whereas democracy, in western democracies and many others, has become a carrier for Capitalism, where Capitalism is at the centre of daily life and of society, democracy in many ways facilitating Capitalism (FIG. 2), now, with the present invention, Capitalism has in fact become a carrier for democracy, where the buying of things has taken on another dimension, empowering the people, and giving the people power to create and affect society. As stated, democracy has been thought by some to mean ‘voting’ for the people. This is a weak translation. Democracy means power for the people. As will be shown with reference to the invention in an ‘OPEN’ setting, the system may be configured so that there are many choices and options for the user. Such ‘choices’ (choosing), may on some level be deemed to be a type of voting.

‘OPEN’ Setting

The invention will now be shown and described with reference to an embodiment where it is not set to AUTO, but is on an ‘OPEN’ setting, where there is provided choices of cause 16 for dispersement for the user.

There is shown in FIG. 6 a box 24 which has an item 10 inside for sale. This item may, for example, be sold at a shop. As will be shown, it may also be sold via a website, or any other sales venue, virtual or real. For the sake of the present example, the item 10 is sold at a shop. The item 10 inside the box 24 is a pet cleaning device 10 (although it could be any item). The system may have particular benefits when used for selling an item(s) particular to a community or group that are biased towards a cause(s).

For example, users who own a dog (and thus buy dog products) tend to be extremely passionate about dogs (and animals). Users would like nothing better than to liberate dispersements to causes associated with helping dogs. Such causes may, for example, provide health care for dogs, may operate on dogs who have eye diseases, or any other ailment, may finance better homing for homeless dogs, or any other cause. As will be obvious, there may be hundreds or thousands of worthwhile causes for helping dogs. Dog owners tend to be very passionate about such issues. In such a situation, users may want more active involvement with the cause(s) dispersed to, and certainly may want choice as to where liberated amounts are dispersed to. They may, for example, want to stay in touch with the cause.

There is shown in FIG. 6 a dispersement indicator 12 on the box 24 to indicate how much profit from selling of the item 10 is liberated for dispersement. In the present example, the dispersement indicator 12 may simply be a print on the box 24. 16.5% dispersement amount indicator 14 is shown. Thus, upon purchase, 16.5% of profit generated from sale of the item 10 is liberated for dispersement—a significant amount if the item 10, for example, retails for $89.99.

If the item 10 is sold by a vendor, for example at a shop, which vendor is not manufacturer of the item, the dispersement amount 14 may be indicative of profit generated by the manufacturer, rather than the vendor. Thus if the manufacturer sells the item 10 at wholesale to the vendor at $30 per unit, and the unit is sold for $89.99 by the vendor, the item 10 may, for example, have had a total cost price per unit for the manufacturer of $19, in which case $11 profit is generated from each unit sale for the manufacturer. (This is in theory since in reality the unit is most likely sold in bulk to the vendor if the vendor is of significant size, therefore manufacturer has already received their profit when an order by the vendor was completed).

Thus, if the dispersement indicating element 14 is 16.5%, $1.82 is liberated. It is feasible vendor may also be configured so that a portion of profit generated from sale of the item by vendor is liberated for dispersement. However, price-point is a key concern for vendors, who, rather than offer dispersements, may want to keep prices as low as possible. Thus it is feasible that the dispersement indicating element 14 (which is also a dispersement amount 14) may be indicative only of a dispersement figure with regards to profit generated by the manufacturer, and not the vendor. However, it is feasible figure represents dispersement by both manufacturer, and vendor, or even that the dispersement indicating element 14 indicates dispersement amount with regard to profit generated from selling of the item by the vendor alone. It will be obvious that some vendors also sell their own brand items. Thus they are brand manufacturer as well as vendor of such items. Such items may be sold using the present invention, whereby a dispersement amount is liberated when the item is sold.

Provider may be manufacturer and vendor as well as provider simultaneously, manufacturing an item 10, selling the item 10, and providing and utilising the system for selling.

In the shown example, there is shown a smart device 26 held over the dispersement indicator 12 icon. It is feasible the dispersement indicator 12 is itself scannable (and the like) to provide information to a user via the, or any, smart device. (Smart devices may not be limited to smart phones, tablets, etc in the future, and may include, for example, computer goggles). Information may also be provided to the user via the smart device simply from proximity to the item 10 and/or code/icon, rather than a scannable icon.

When a smart device is used in such a way to gain information about an item 10, for the sake of the present application, it is termed ‘connection’, or ‘connecting’.

There are shown elements on the phone reading ‘LINK’, ‘PUSH’ and ‘sign in’. These will be discussed proceedingly.

As aforementioned, it is feasible media and/or any information is shown to the user, such as a video, via the smart device 26. (This is ‘connecting’). For the present example, it will be presumed that there is provided a choice of causes that the liberated amount may be dispersed to when the item 10 is purchased by a user. (Not shown in FIG. 6)

Thus information relating to causes may feasibly be relayed to the user via a smart device 26. Cause(s), as aforementioned and shown, may also be indicated to a user via a tag, sticker, signage and the like, any of which is a dispersement indicator 12.

It is feasible that choice of cause for dispersement may be choosable by the user prior to buying the item (perhaps via the smart device 26). This may require integration with an account for the user. Thus if a choice is made for cause to disperse to, the choice may be stored on the user account, which account may be configured to recognise when the item 10 has been purchased by the user, and then accordingly disperse the liberated amount to the chosen cause. This may require significant computer and information database actions and/or storage by the system, implemented by computer.

In future retail systems, it may be feasible that the item can itself be bought simply via a smart device by the user—at the present moment, and over the last several years, more computerised tills are being utilised by large vendors, whereby an item is bought by a customer and scanned through a computer, rather than a manned till, thus not requiring a member of staff. In future settings, it is feasible payment may be makeable by a customer directly via a portable smart device (such as a smartphone 26) in the shop itself, and that there are provided systems by the vendor so that if a customer leaves only with item(s) they have purchased via the, for example, smartphone 26, no alarm is triggered and they may freely leave the shop with their item(s), and so that if they have any items that have not been paid for, an alarm is triggered. Such a system may incorporate an alarm gateway (similar to an airport scanner), whereby a user walks through a gateway (or terminal) that includes technology for checking if items have been paid for. This may require interaction with local computer systems and technology to be incorporated, so that substantially immediately when a purchase is made by a customer via a smart device, the item is recognised as sold by the vendor and alarm system, the system configured to thus not trigger an alarm. Use of such a system may necessitate use of a camera to film customers leaving the gateway and/or sales venue, and a doorman.

Thus it can be seen that, feasibly, choice of cause for dispersement may be made by a user before or during purchase of the item 10.

Returning to a more traditional method of purchasing the item 10 as shown in FIG. 6, purchase of the item 10 may be made via a computer till (which are used in many supermarkets and the like), or via a manned till, where a staff member uses a till to process the payment.

If the sale is processed via a non-manned computer till, the computer may provide a screen for the user so that choice can be made by the user as to which cause to disperse a liberated amount to. There is shown in FIG. 7 a basic embodiment of a choice screen, which may be provided on a computer till for a user (or feasibly on a PC, smart device, etc dependent on what platform user is purchasing the item 10 from). For the sake of the example, names of causes are shown as ‘Cause 1’ 30, ‘Cause 2’ 32, and ‘Cause 3’ 34. In action, the causes have names, such as ‘dog care home’, ‘new veterinary surgery’, ‘poaching lookout post’.

If the computer till is touch-screen, choice may be made by the user by touching the screen (and the relevant choice). A similar such choice screen may also be provided if purchase of the item is made online, in which case choice may be made by a user via point and click using a cursor, mouse, etc and the like. If such a choice screen is provided on a computer till, the computer will require information as to which causes can be dispersed to by buying of the item. This may be done manually so that the choices are inputted into the computer system, or it may be done automatedly, via a computer system. Such a system may be achieved in many ways that will be obvious to those with skill in the art. Such information may be included on, or triggered by scanning of the sales scan code of the item. Typically, in order to process sale of an item at a shop, supermarket, etc, an item is scanned, which scanning is acknowledged by a computer system which either holds information, or is delivered information about the item, such as name of the item, price etc. This information is later used to generate a receipt, total cost, and may also be used for accountancy and stock reasons by the vendor.

In such like manner, information pertaining to dispersement cause(s) for an item may be either delivered to the system via scanning of the item 10, or may be held on the system and triggered by scanning of the item, scanning of scannable element, for example, used in a similar way to regular purchasing to extract dispersement information.

It is feasible that computer systems for all locations that sell the item are provided with information that pre-configures their computer systems to provide correct cause choices for the user and/or correct and global dispersement information. This information may be drawn from the present invention system, the system incorporating a data storage facility for dispersement information and any other information.

The item having been recognised as an item that incurs liberation of a dispersement amount when purchased and has a cause choice for the user, choice is provided to the user. If payment is made via unmanned computer till at, for example, a shop, or on a computer at home (for example whilst buying via the internet), there is preferably provided a choice screen as shown in FIG. 7. (Dotted line 28 represents a computer monitor screen, terminal screen and the like), although such a choice screen may also be provided on a PC, smart device or any other platform purchase of item 10 is made upon.

If payment is made by card at a manned till, it is feasible that cause choice can be made by the user via credit card reader port/terminal (which is a port for processing a credit card transaction, into which a credit card can be inserted and which tends to have screen relaying commands to a user such as ‘key in PIN number’). Thus a message may be provided on the card reader port/terminal requesting user to choose a cause, which may be choosable by pressing of relevant buttons, etc, similar to screen as shown in FIG. 7, or may be touch-screen.

It is feasible cause choice etc is not provided at point of sale, and that dispersement information is relayed to a user account, which may, or may not, require scanning (and the like) of an interlocuting element, such as, for example, a card.

If there is media associated with the causes (such as a video by the cause to explain merits of dispersing to their cause), there may be provided clickable or touch clickable links 36 for a user to view a, for example, video. This may not be conducive to quick selling at a sales venue such as a shop. Therefore such an option may only be afforded for selling via the internet when the purchase is made online.

If payment is made at a manned till, it is feasible an added step is required, such as till staff member asking user which cause they would like to choose, or till staff member asking user to choose cause via a computerised terminal, (which may be a (modified) card reader port/terminal, or may be a different unit altogether).

Thus it can be seen that choice of cause can be made by the user at time of purchase.

However, it is also feasible that dispersement cause may be choosable by a user after purchase has been made.

There may be provided a ‘LINK’ protocol. As shown in FIG. 8, user may be provided with an option to ‘LINK’ with cause they have liberated a dispersement to. This may be provided via a screen (on a PC monitor screen, smart device screen, computerised till, terminal, or the like). For this and other reasons, it may be desirable to provide a user using the present system to buy an item an account. Preferably the LINK is set up so that the user is contactable by the cause, so that, for example, an email may be sent to the user by the cause when a limestone has been reached.

Thus by clicking and/or choosing ‘LINK’ option 38, user and cause are linked, and by choosing ‘NO’ option 40, user and cause are not linked.

User Account

In order to facilitate this (and for other reasons), it may be desirable if there is provided an account for the user. An account may be useful for several reasons.

If an account can be created by the user via the selling system (or a (computer) system integrated with the system for selling), information of the user can be stored by the system. Such information may include name, bank details, etc.

The account may include (or be used in integration with), a data storage facility so that data regarding dispersement of funds is viewable by a user and/or provider, and/or stored.

A payment system may be integrated into the system, so that, for example, a user can integrate a credit card(s) with the system, whereby when they make a purchase for an item (such as the item as shown in FIG. 7) with the credit card, the system acknowledging that an item that either has incurred, or may incur, a dispersement, has been purchased, and relays that information onto the account of the user.

One benefit of providing users with an account is that cause choices may be made after a purchase has been made. Thus, for example, a user may log in to their account, where information regarding dispersements may be viewable.

There is shown in FIG. 9 an example embodiment of a webpage (and the like) viewable by a user when they have signed in to their account.

Preferably, similar to Paypal-type systems, user may use an email address as their main username. This has benefits as sending information to the user by email may be desired and/or required. Preferably such an account is password protected so details and information of the user are protected.

There is shown in FIG. 9 a plurality of clickable buttons and information on the page. Basic information is stored on the system, and displayed for the user.

As is standard for such interfaces, there may be provided clickable headers 42, 44, 46 to direct to useful and/or important pages within a user's account. There may be provided a My Account page header 42 (the ‘My Account’ page presently viewable as FIG. 9), a Dispersements page header 44, where information pertaining to dispersements made or pending by the user are viewable, and an ‘Integrate Bank’ header 46, whereby a user can integrate a credit card, bank account, (and feasibly Paypal account and the like), etc with the system. This is a possible means by which integration can occur whereby a purchase made via credit card, bank account, etc of an item that incurs liberation of a dispersement of a user is recognised by the present system and information pertaining to dispersement is received by the system.

There is also shown an ‘Integrate New Payment Method’ button 48, which can be chosen by a user to integrate a new bank account with the system or a new method of payment so that liberated dispersements are recognised by the system and the information relayed to user account.

There is shown a ‘Get i-card’ link 50. Feasibly the system incorporates its own payment system, or has a system whereby a card or the like is provided to a user which can be scanned and the like when purchases are made at a vendor. Such a card may intelligently verifiy user so that dispersement information is recognised and received by the system, which information may be viewable by a user on their account.

Thus, for example, if the pet cleaning device is purchased by a user at a vendor by credit card, cash, or any other method, it may be necessary for an i-card of the user to be swiped (and the like) so that dispersement information is stored and recognised by the system. Thus i-card acts as interlocutor between purchase and user account. This may be necessary dependent on system infrastructure for allowing a user to make post-purchase cause choices. In such an i-card configuration, system of vendor may recognise purchases that incur a liberation, but may require scanning (and the like) of a user card (and the like) in order for dispersement information to be relayed onto user account.

Thus it is feasible that user may be provided with a relaying element (such as a card but not limited to a card), which can be scanned (and the like) for relaying information to account of the user. Such information may also be stored on the system and/or user account.

It is also feasible the ‘i-card’ is a payment system all of its own, and that the system incorporates its own payment system. Thus the ‘i-card’ may function similarly to a credit card.

There are other clickable links: ‘Overview’, ‘History’, ‘Profile’, which are not unusual for such accounts.

There is provided an ‘Adjust Settings’ tab 52, which may take user to settings of user's account and allow user to alter settings of the account. This may alter purchasing and dispersements experience and may limit (AUTO) or expand (OPEN) choices for the user when using the system. This will be discussed in greater detail with reference to Account Settings.

There is provided a welcome message 54 for a user. (Preferably the word ‘user’ is replaced with name of the user).

There is provided ‘Dispersements Pending’ information 56. This indicates to a user a total amount that has been liberated, but not yet been dispersed to a cause(s) by the user, as a result of purchases made where a cause has not yet been chosen by the user.

There is shown ‘Dispersements Total This Month’ 58, where total of all liberations and/or dispersements made in the month are shown. (This may also appear as (and/or be) ‘Liberations Total This Month’, a total thus being shown of total amount liberated via purchases for a month).

There is shown details of two purchases 60, 62 that incurred a liberation amount, and various details and options which will now be described. Details of liberations resultant from purchase of the Pet Cleaning Device 60 are shown in substantially linear fashion across a page.

Date 64 of purchase is shown.

Type 66 of purchase is shown as ‘OPEN’. This denotes selling setting of the item 10 and that cause choice is, or was, provided to the user.

Item 68 name is provided, which in this case is ‘Pet Cleaning Device’.

Dispersement status 70 is indicated, which, in the present example, is ‘Pending’. This indicates that an amount has been liberated by the purchase, but that dispersement has not yet occurred. This may be because a cause has not yet been chosen by the user.

A ‘Details’ 72 link is provided. Underlining denotes that the word ‘Details’ is clickable by a user so that more details about the purchase and/or dispersement can be viewed by a user.

Cause 74 column is provided, where cause dispersed to is indicated. In the present example, user is indicated to ‘Choose’, indicating that a cause has not yet been chosen to disperse the amount to. A play icon 76 is provided by the clickable ‘Choose’ link, indicating to a user that media is provided, which media may be a video or videos of potential cause(s) that the liberated amount can be dispersed to. Thus the ‘Choose’ (underlined) link can be clicked by a user, media can be viewed, and a choice can be made by the user so that the dispersement amount is dispersed.

There is provided a ‘PUSH’ 78 column and link for pushing a cause. Pushing a cause alters settings on a user account to bias dispersements toward a cause. There are multiple uses for such a protocol; if a cause is particularly important for a user, they may want to bias their account settings to disperse liberated amounts from purchases to the cause. ‘PUSH’ may be a local setting, or a global setting. For example, if user chooses a cause related to item Pet Cleaning Device, which cause is a home for injured dogs, with, for example, a mission to complete to improve habitation of dogs in the home, user may want to ‘PUSH’ the cause to help cause fulfil its mission.

Thus, if a cause it chosen, or viewed, there may be provided a ‘PUSH’ option, button, etc for a user. If the cause is pushed by the user, amounts may be dispersed to the cause even for purchases where the cause is not chosen for dispersement, and even for purchases where the cause is not a choice for dispersement.

As aforementioned, ‘PUSH’ may alter user settings locally, or globally. For example, a user may PUSH the said example cause locally, which alters settings so that, for example, all dispersement items purchased by the user in the similar or same field of dogs and dog care disperse a portion of the liberated amount to the pushed cause. Thus the cause is pushed further in its goal.

In the given example, if a cause ‘dog care home’ is pushed, if an item 10 is purchased by the user at any time whilst settings are set to push the cause, even if the cause is not a choice for dispersement for an item, a portion of the liberated amount from purchasing the item may be made available for dispersement to the cause, or may be substantially immediately dispersed to the cause. It is feasible a cause can be pushed wholly, so that all liberated amounts are dispersed to the pushed cause. However, preferably a portion of dispersements, (rather than whole dispersements), are dispersed to the pushed cause. If the cause is pushed locally, then only items purchased that liberate dispersements in the or related fields to the cause may incur a pushed dispersement to the cause. If the cause is pushed globally, then it is feasible all items purchased that liberate dispersements in any field (including fields wholly unrelated to dog care, animal care, etc) incur a pushed dispersement to the cause.

Thus there is provided significant means for user to establish and alter settings for their account and experience.

Preferably Push protocol is carried out intelligently by the system via programming that is globally available to users. Fairly significant and complex programming may be required in order to achieve such setting alteration.

It is feasible multiple causes can be pushed.

There is shown a LINK 80 column and link. Once a cause is chosen for dispersement, LINK protocol allows cause to have access to user (preferably via email) so that news, information, updates, etc may be provided by the cause to the user. There may be provided regulations by the provider to causes, so that, for example, a cause may not repeatedly message users for added dispersement. It is feasible added financing by the user for the cause may be allowed. Preferably the system has integration with at least one, and feasibly many payment methods and systems, such as credit card, Paypal, etc. It is also feasible an in-house payment system is incorporated into the system, which may also be usable for the user in any other purchase of any item, not limited to items that liberate a dispersement when purchased.

Preferably LINK protocol is only provided to a user once they have dispersed to a cause so that LINK can only be established to causes user has dispersed to. It is feasible any cause can be linked to.

Preferably login to user account is achieved by the user by entering an email address and a password, user account thus password protected. Using email address for login has several advantages; it is easy to remember for the user; the email address can be used by provider of the system to contact user; and email address of the user can be used to set up LINK to a cause. Thus preferably an email address is provided by the user in opening an account. User may provide a separate username, and may create a password.

There is shown a dispersement amount 82 column to show liberated amount from purchase of the listed item that can be dispersed. For the present example, $4.69 has been liberated for dispersement by purchasing the pet cleaning device. User is now free to use the system to disperse the amount to a cause.

There is shown a second purchased item 62 (the baseball cap as shown in exemplary fashion in FIG. 4), that has incurred a dispersement. Date is shown of purchase. Type column reveals purchase is categorised as ‘AUTO-s’. This is shorthand for ‘AUTO-SYSTEM’ or ‘AUTO-SELLER’, which indicates that the cause that the liberated amount was dispersed to was not chosen by the user and was AUTO-dispersed to a pre-determined cause set by the seller (or feasibly the provider). The type of purchase is indicated as ‘AUTO-S’ and not simply ‘AUTO’ because ‘AUTO’ setting can also be set by user to decline from making decisions as to where liberated amounts are dispersed. Shorthand for this is ‘AUTO-U’, which is shorthand for ‘AUTO-USER’.

Thus there are two forms of AUTO setting:

AUTO set by seller, where seller has pre-determined only one cause that liberated amounts can be dispersed to. (Example: cap where dispersement is automated to ‘Liverpool Street Clean’). When seller has set dispersement to AUTO, even if user has set their account to OPEN setting, dispersement is made to the cause without choice from the user; and

AUTO set by user, where user has chosen a setting of AUTO for their account (and therefore experience) where no (or substantially no) choice is provided to the user as to where liberated amount is dispersed to when purchase is made. This may be beneficial for users who prefer to buy quickly and do not want a particularly interactive and/or time consuming experience with the system.

Seller may be able to set AUTO dispersement to multiple causes when an item is purchased. For example, dispersement may be split on AUTO between three causes. Nevertheless, if the dispersement is set to automatically be dispersed without choice from the user, it is said to be set to a setting of AUTO.

Seller may be provided with facility, even it item sale is not set to AUTO, to choose where/how liberated amounts will be dispersed for users that have set account settings to AUTO. In another example, the system (the present invention) may choose intelligently where liberated amounts are dispersed to in cases when an OPEN setting item is for sale (so that a choice of causes is provided for a user) and item is purchased by user who has set account to AUTO.

It is feasible settings are available that gradient between OPEN and AUTO, so that, for example, user can set account settings so that they are provided with choice of causes on OPEN set items for sale (where there is a choice of cause) but only provided with a choice on 50% of such occasions, or 70% of such occasions, etc. Thus user experience is optimisable for the user via alteration of settings. As will be shown, it is feasible settings are user settings are dynamically adjustable via use of the system on external websites.

Thus there is shown a purchase ‘Type’ of AUTO-S for purchase of the baseball cap since the dispersement cause was predetermined by the seller. (It is feasible dispersement cause may be chosen by entity other than seller).

Item name is given.

Dispersement status for the cap is shown to be ‘Complete’, which would be expected on an AUTO-S item, since dispersement cause was pre-determined.

Details link is provided.

Cause is shown. A play icon 76 denotes that media can be viewed by a user about the cause. It is feasible that under, for example, a video provided by the cause to view (which the user may be redirected to when the ‘play icon’ link is click), there may be provided options to PUSH and LINK. PUSH and LINK options, button, etc are not limited to user account pages, or websites, and may appear anywhere, including the external world; for example, posters, etc, which may then be read by a smart device.

There is shown dispersement amount, which, for the present example, is 99 p. It is feasible different currencies are shown if user has purchase items in different countries and/or currencies.

Thus dispersement information is provided to a user via an account, which is preferably password protected and allows user to alter account (and therefore dispersement) settings.

It can be seen that £0.99 has been dispersed to Liverpool street clean via purchase of a cap on 25 May 2013.

(Lines underneath the two examples are an artistic representation intended to indicate that there may be shown more items that have been purchased by the user and have liberated dispersements).

It is feasible there is a significant social media aspect to the system, whereby users can connect, comment, take part, interact, send to friends, invite friends, etc.

Spontaneous Cause Creation

There may be provided further options for users or ‘entities’. For example, there may be provided a ‘Create a Cause’ option and/or button. Such a button may be provided anywhere about a user account or anywhere on any website, and feasibly on a poster etc that can be read with a smart device; thus not limited to being provided only on the user account. Thus users may create a cause, and feasibly begin to use the system as a Cause.

There may be regulations required (and enforced) by the provider in order to set up a cause. For example, a video may be required explaining the cause. Such videos may be monitored and regulated for quality, or may not be. It may be necessary for bank details to be supplied by the new cause so that liberated amounts can be dispersed to the cause, or for information to be provided that facilitates the system in relaying dispersements to the cause.

Thus a user, or group, may spontaneously create a cause. A cause may include a mission to fulfil.

Thus it can clearly be seen that there are feasibly four party elements involved and using (or subject to) the system:

Seller;

User;

Provider; and

Cause.

Each may have an account or separate account set up. Account types may be different for users, sellers, and causes. Therefore a login page for a seller may look significantly different to a login page for a user (as shown in FIG. 9.).

There is shown in FIG. 10 a basic skeletal representation of a seller page, where a seller can set up dispersement parameters (and other information) for dispersement items.

Preferably the seller account is password protected, and may feasibly require a separate password and/or protection system that a user account. It is also feasible that a user may have a user and seller account with the same password and/or protection.

Seller may, for example, be a manufacturing company who sells to retail vendor(s) at wholesale price. Example is shown of the cap as shown by example in FIG. 4. Information has been provided by the seller, columns of the table filled out.

There is provided an ‘Item Name’ 84 column, where name of the item has been filled out by the seller.

There is provided a ‘Liberation (%)’ 86 column. A 25% of profit liberation amount has been decided by the seller. Preferably, as shown in the example embodiment of FIG. 10, the liberation amount is a percentage of profit when item is sold. However, it is feasible liberation amount is a set amount, rather than a percentage, and a drop-down menu and the like may be provided so that such an option for set amount for liberation may be provided by the user, whereby an amount, eg $6.00 can be filled out by the seller. This feature may be important for goods that sell at high prices (and profit) where less units are sold.

There is provided a ‘Profit Per Unit’ 88 column, where a profit-per-unit amount has been filled out by the seller. In the present example, total profit per unit has been filled out by the seller as £3.96.

There is provided a ‘Dispersement Amount’ 90 column. Preferably, with such parameters set, the system calculates the dispersement amount from the figures provided by the seller. For the present example, dispersement amount per unit is £0.99.

There is provided a ‘Cause(s)' 92 column, where a cause or causes can be chosen by the seller to which liberation amount is dispersed when item is purchased. There may be provided a search box/function and significant help for seller in finding and choosing a cause(s). Once decided, seller may input cause(s) into the ‘Cause(s)’ column. If only one cause is selected for dispersement, ‘Setting’ 94 column is automatically set to AUTO since there in no cause choice for a user (buyer). If multiple causes are chosen, seller has choice whether to set selling setting to AUTO (liberation amount is dispersed to all causes with no choice for user), or to OPEN, whereby user is able to choose to which of the causes to disperse the liberation amount.

(If the user sets AUTO when there is more than one cause, it is feasible a menu may be provided whereby percentages of the dispersement amount can be allocated to each cause individually, so that, for example, one cause receives more dispersement than another when an item is sold).

There is provided an ‘AUTO-U’ 96 column. As stated, is user has set account settings to AUTO, even if the selling setting of the item is OPEN, their dispersement will be automated, without choice from the user. In the AUTO-U (AUTO-USER) column, seller can define (if there are more than one causes for dispersement) where/how the dispersement will be allocated if buyer (user) has buying settings set to AUTO. Seller may set AUTO-U setting to default, in which case dispersement may be shared equally amongst dispersement causes, or may allocate any other setting, such as only one cause being dispersed to by AUTO-U buyers, or percentage allocation, etc.

For the present example, AUTO-U column has been defaulted to N/A by the system, since there is only one cause for dispersement. Thus there is no need for an AUTO-U setting.

There is provided a ‘Get Code’ 98 column. Once all details have been filled out, there may be provided a code for the user. This code may, for example, be usable on a website and integrate with a payment system, payment cart, payment button, and the like, and may automatedly carry out the dispersement when a purchase is made. The code may be an HTML code, javascript, iframe code (and the like) that automatedly carries out the function of separating the dispersement amount from profit of the item sold, which code may also send dispersement information to user (buyer) account when item is purchased. Thus it can be seen that code may be provided to seller for selling the item and executing commands relevant to liberation amount dispersement, and feasibly executing commands relevant to relaying of dispersement information to a user account.

In an alternative embodiment (which may be provided alongside the previously mentioned ‘Get Code’ protocol), the code may be for creating of a QR code (and the like) or a dispersement icon for attaching, printing, etc, and applying to goods for sale at retail. If a QR code is provided (which may in fact be a QR-icon which may be downloadable, copyable etc for the seller), the QR code may be usable on a website, poster, may be printable for use on a retail product, etc.

It is feasible such a method may be used to create a dispersement indicator 12 for a product, which can be applied to the product to indicate to a user dispersement amount information, feasibly thus also being a dispersement amount indicator 14 and/or icon 20. This may also have use for vendors and may be sent by sellers to vendors, or may be provided to sellers via a seller account on the system or by integration features in the system between seller and vendor if they are different entities.

There is provided a ‘Get Badge’ 100 column. This may provide seller with a badge, icon, indicator, etc that can be used on a website or a physical product as a dispersement indicator 12 to indicate to a user that an item liberates a dispersement when purchased.

Thus it can be seen that badges, icons, indicators, code etc can be generated via an automatic, or substantially automatic computer implemented method and/or system.

There is shown in FIG. 11 a basic embodiment for a cause creation page (and cause account creation).

As stated, it is feasible any entity and/or user can set up a cause (or cause account). Bank details (or similar information may be required for liberation amounts to be dispersed to. It is feasible Paypal-type accounts (virtual bank accounts) or any other such account details may be provided. Thus liberation amounts can be dispersed to the cause. It is also feasible there is provided a virtual bank for the cause.

Information such as ‘Cause Name’ 102 may be required. The embodiment is provided by way of basic description and example only.

There is provided a ‘Cause Description’ 104 box for a cause to fill out.

There is provided a ‘Field’ box 106 which may incorporate a drop-down menu so that a field or category for the cause may be provided, such as ‘animals and pets’, ‘health’, ‘music’ etc. There may be provided sub-categories so that an exact filed can be provided by the cause.

There is provided a ‘Mission’ box 108, where either a cause can state its mission statement, or provide a mission the cause aims to fulfil. Thus, when liberated amounts are dispersed to the cause, it can fulfil its mission, at which point a new mission may be created, or dispersements may be ceased.

There may be provided a ‘SEND LINK’ box, which facilitates a cause in sending a (video) message to users who have linked with the cause. However, this option may not be available at first screen for cause creation. There may be provided dedicated tools, software and the like for facilitating a cause in sending a LINK message to users.

There is provided a ‘Video’ Box 110. A URL of a video from a video hosting site may be provided in the box so that the video can be uploaded and/or shown to promote the cause. Video is a particularly entertaining and informative media platform. Thus it may be required for a video to be provided by the cause for users to view.

There may also be provided a video upload button so that video files (such as MP4 and the like) can be uploaded to the system, the system hosting the video.

There is provided in the example embodiment a bank details box 112 so that bank details (or virtual bank account, etc) can be provided by the cause so that there is provided an account for liberated amounts to be dispersed to.

(When a cause has been set up, there may be provided a tracking page where all details of how much liberated amounts have been dispersed to the account, how many purchases incurred the dispersements, total to complete mission, etc are provided, so that cause dispersement information can be tracked by the cause.)

There is provided a PUSH button box 114 where code (HTML, etc) may be generated by the system for cause to use as a PUSH button on a webpage and the like.

There is provided a PUSH Icon image 115, which may be automatedly generated by the system and may provide a, for example, QR-type code which can be used on a poster and the like so that a user (who may or may not be a buyer) may aim a smart device at the icon (or scan it and the like) in order to facilitate pushing of the cause by a user. Such an icon may, for example, relay a page viewable on user's smart device, which includes a button to PUSH the cause. Such a screen may include a call-to-action for a user to create a user account for the system if they do not have one, so that they can PUSH a cause. The Icon may be provided as a high quality image download, or may be a code, programming language, and the like. The PUSH icon image could be said to be a connection facilitating element, since it may facilitate connection with a user(s) via a smart device.

There is provided a LINK button box 116, which may generate and provide code for a LINK button for the cause, which code may be used on a website, etc.

There may be provided a LINK icon box.

There is provided a preview window 118, where the cause video 120, which has been uploaded or embedded onto the site, is previewable, along with PUSH 122 and LINK 124 buttons, which may be testable by the cause.

There may be provided a Homepage and/or website for the cause (such as a template), where cause video, push button, link button, etc can be viewed by user. Such a page may be simple, featuring just video, and PUSH and LINK buttons and feasibly a call-to-action for users that do not yet have an account so a user account can be set up, which may be required in order to PUSH and/or LINK a cause. Such a page may be automatedly generated by the system when cause has been set up.

Thus it can be seen that the system may incorporate four party elements:

user; provider; seller; and cause, and that there may be any number of users, sellers, and causes, the system being scalable.

PUSH When No Purchase is Made

The present invention opens up opportunities for financing, even when a purchase is not made.

It will be well known that many communities have run down areas and/or sites.

As has been shown the present invention may be particularly useful in communities.

In many communities, for example, there is a park(s) with an outdoor tennis court usable by the public. Such courts are typically made of gravel, are not well kept, and may have weeds and plant matter growing on the court. They typically have nets that droop, and are not well kept. Many such courts become substantially unusable and are regularly seen unused.

This is just one example of a run-down area in a community.

In such an example, a cause may be set up, for example by a resident. It is feasible the cause can be set up spontaneously via similar means as aforedescribed, with particular reference to PUSH function. A video may or may not be required to set up the cause. If a video is required, it may simply be filmed on smart device and uploaded immediately to the system, or uploaded to a well-known video platform and either embedded onto the system via code, or shown via URL.

As shown, (and described with reference to FIG. 11), cause for the tennis court may be created and PUSH, LINK buttons and preview may be generated and shown in the preview window. As stated, a QR-type image may be created and downloaded from the cause creation page, as well as a PUSH image (for a poster and the like) and feasibly a dispersement indicator image to indicate to a user that dispersements can be made.

Thus a poster and the like can be placed at the scene, perhaps on the gratings of the court, visible to passers-by in the community, indicating that the tennis court is now a cause dispersements can be made to. The dispersement indicator 12 may simply be a symbol which is recognisable to users as a symbol which means a dispersement can be made to the cause. Primary intent is to get users to PUSH the cause, which, as stated, may feasibly be done locally or globally by the user.

The poster may include the PUSH image which may be a connection facilitating element, and may be a QR-type element. Thus, if a user is in proximity to the printed element, or scans the code and the like, there may be shown on their smart device a screen as shown in FIG. 12, the user thus connected to the cause via the smart device. The screen is substantially identical as the preview window in the cause creation page of FIG. 11.

There is provided on the smartphone screen the cause video 120 (which may have been recorded by the cause creator via smart device), a PUSH 122 button, and a LINK button 124. User can watch the video to see what the cause is about, and what mission of the cause is. User may be able to post comments, upload a response video, etc. If user hits the PUSH button and the user has a user account for the invention as shown in FIG. 9, user may be prompted to choose whether they would like to PUSH locally, or globally. Settings for user account are accordingly altered to bias dispersements to the cause.

If the user has not yet signed up for a user account, they can choose the ‘Sign Up Now’ button 126 and create an account.

Thus when user purchases items that liberate dispersements, a portion of dispersement may be dispersed to the cause. If cause is pushed locally, a limited amount of dispersements may be dispersed to the cause. If cause is pushed globally, a portion of substantially all dispersements may be pushed to the cause.

Thus it can be seen that a cause can be pushed where there is no sale initially made, and the PUSH function can be used to finance a project, via quick and spontaneous cause creation.

In a similar community example of where PUSH function of the present invention can be used where there is no sale initiating the process, there is shown in FIG. 13 an attempt to raise funds which has been shown throughout many industries to be significantly unsuccessful. In FIG. 13, the present invention is not used. FIG. 13 is used as a comparative example to FIG. 14 where the invention is used.

There is shown in FIG. 13 a wall surface 128, situated near to an exit of the library so that it is seen by all those leaving the library. There is provided a poster 130 on the wall with a call to action for users of the library to ‘support your library service’ and give money to the library. There is shown on the poster a miscellaneous picture of a man 132 reading a newspaper 134.

Under the poster 130 there is provided a glass or transparent plastics box 136 which has a slit 138 money can be placed in. There is shown pennies 140 in the box. The poster reads ‘every penny counts’. The poster is a call-to-action for users to place money in the box to help finance the library. Some people (over a long period of time) have placed pennies in the box. However, the system is extremely unsuccessful, and despite tens of thousands of people passing by the attempted financing system every year, extremely little financing is received and achieved.

A particular problem with the shown system (which does not use the present invention), is that it asks people to ‘donate’ money—that is to give money out of their own pocket—financing that is outside of their normal spending. Humans are genetically equipped to act in their own interest and to the benefit of their own survival (and prosperity). This is not to say that humans do not (or cannot) also act in the interest of others. However, donation of money outside of normal spending is equated by many with loss of money, which is against the interest of the user.

The call-to-action is extremely vague—it would be desirable if the call to action specified where financing would be driven, and suggested a result tangible for the user. It would also be desirable if the user were able to finance the project with no spending outside their normal spending—that is, at no cost to them.

There is shown in FIG. 14 a modification of a same scenario as that seen in FIG. 13, where the present invention is being used, particularly with reference to a PUSH function of the present invention.

There is shown the same wall, and a similar poster, with a man reading a paper. There is clearly shown a ‘PUSH’ icon 142 (this may be a dead image that has no technological function, or may be a scannable (and the like) element 18 that initiates and/or facilitates a PUSH function for a user with a smart device. The PUSH icon itself is also a call-to-action for the user, and may be deemed a dispersement indicator 12 if it is recognisable as such to users.

There is shown a call-to-action which reads ‘Push our cause to create a new audiobook wing. Link up’. This is far more desirable as it defines to user benefit both for library and user—they will receive a new audiobook wing if the cause is pushed successfully. This could be said to be a ‘mission’ of the cause. This mutual benefit aspects significantly assuages ‘loss’ issues for the user, who may feel that pushing the cause is in their own interest. There is shown an amusing call to action ‘Push us over the edge dear chap!!’ which plays on the meaning of ‘PUSH’, and further implores user to use PUSH function top finance cause.

The PUSH icon 142 itself (which may simply be a printed image), may act as a scannable element and the like, or there may be provided a separate QR-type code and the like, which is configured to initiate an ability for user to PUSH and/or LINK with the cause. It is feasible that no scannable element is required and that proximity to the cause poster, icon, etc initiates facility for user to interact with cause via a smart device.

The push icon image 142 may have been created (and printed) via the cause creation page of FIG. 11. Similarly a scannable (and the like) element 18 may have been provided by the system and/or created (and printed) via the cause creation page as shown in a basic example embodiment in FIG. 11.

There is shown a scannable element 18, if required, and if the PUSH image, icon 142 etc is not itself a scannable (and the like) element.

There is provided a dispersement indicator 12, which here is a symbol, (which here is symbolic of the present invention) which may be a logo and the like that is recognisable to users as a symbol that indicates that dispersement to a cause can be initiated at this place/via the symbol. The symbol itself may be a scannable (and the like) element, which, for example, when a smart device is held close to it, facilitates a connection between user and cause via smart device. Such technology is well known to those with skill in the art.

No money box is provided. Intent is for user to use smart device to PUSH library cause so that, preferably with no payment made by the user outside of their normal spending, settings of user account (as shown in FIG. 9, etc) are altered to bias dispersements to library cause via purchasing of items that liberate dispersements.

If cause is pushed by user, purchasing of items that liberate a dispersement, even if library cause is not a cause choice (and feasibly even if selling setting is set to AUTO), may disperse a dispersement (or a portion of a dispersement) to the cause. It is also feasible that PUSH dispersement is handled on a time period basis, so that, for example, a portion/percentage and the like of all dispersements over a monthly period are tallied, with a portion of total dispersements of a user dispersed to a pushed cause of the user. Such calculations may be handled intelligently by the system and/or user account, which user account may be said to be an incorporated part of the system. (Intelligent pushing by the system may involve system recognising how much financing a cause requires and intelligently deciphering priority on a user account as to how much should be pushed to a cause. For example, if a cause mission is fulfilled, system may intelligently stop dispersement by a user even if cause is pushed by the user, dispersements thus being pushed to other causes being pushed by the user).

Similarly, system may recognise (and calculate) how much financing a cause (and/or cause mission) requires, and how many users the cause is presently being pushed by, and may prioritise dispersements accordingly.

An App and the like may be required for the user for smart device connection.

Preferably, when user connects to the cause via the smart device, for example hovering the smart device over a scannable (and the like) element, they are met with a screen similar to that as seen in FIG. 12, where there is provided a video by the library (if there is provided a video, a simple name of the cause may be provided), with a PUSH button and a LINK button. Intent is for user to PUSH the cause, which, if done, may elicit a further request from the device as to whether to PUSH locally, or globally, or to adjust and/or configure settings for how to PUSH the cause. (This may involve prioritization, which may alter user account settings).

Preferably, a LINK protocol can only be initiated with a cause that has been pushed. Therefore, if user has not pushed the cause, and selects LINK option, preferably a message appears on screen informing user that LINK can only be established with cause if cause is PUSHED and whether user would like to PUSH cause.

If user has a user account with the system (an aspect of the present invention), user may be required to sign in, or may already be signed in. If user does not already have an account with the system, they may choose the ‘Sign Up’ button in order to create a user account for the present system, which may involve providing information such as an email address, a password, and either integrated with a payment option (such as a credit card previously owned by the user), or using a payment system incorporated as part of the system.

This achieved, a cause can be pushed by the user.

Intent is that dispersements from purchased items that liberate a dispersement will be partially syphoned to the cause. Thus it can be seen that PUSH function can be initiated by the user with no payment made, and that the cause can be pushed (and thus financed) with no spending outside a user's normal spending—if they leave the library and pay standard retail price for an item that liberates a dispersement, a dispersement may be dispersed to the cause (which may be a substantially immediate dispersement, or may be tallied from a dispersement total of the user's account/activity).

User may be able to send details of cause to friends etc, and may be able and/or facilitated to create groups with friends and the like to help causes. Social media and sending buttons etc may be used for this.

As described and shown in FIG. 11, library cause may have been set up quickly and substantially spontaneously. Video may have been recorded, either professionally or simply by a staff member using a, for example, smart phone to record video. Basic description of cause may have been provided, with mission etc, which information may be provided and viewable when user holds smart device to scannable (and the like) element. Cause may also be searchable on the smart device for the user. For example, cause name may appear on the poster. Thus user may go to account/system on smart device, and search for the cause manually, which may facilitate pushing, etc.

Once cause has been pushed, user may be asked if they want to LINK to cause, as shown in FIG. 8. It is thought that approximately 100 times as many people will finance the cause via this method rather than the unsuccessful traditional method as shown in FIG. 13.

There may be provided limitations on a user account as to how many causes can be pushed. Such limitations may be handled intelligently by the system, and may include calculations as to how much dispersement is made by user, for example, per month.

User may be able to unlock features in their account, such as ability to PUSH more causes. System may intelligently stop pushing a cause by a user after a particular amount of time. For example, pushing may have to be re-confirmed every month; message may be emailed, or sent to smart device of user to ask for confirmation that cause should be pushed by user approximately every month. This may help to limit amount of causes being pushed by user and ensure causes is not continually (and forgetfully) pushed by a user, thus freshening pushed cause data for a user.

Thus it can be seen, both in a case of a run-down tennis court, and in a case of a library financing for an audiobook wing, that the present system can be used in a community (or any) setting to arouse economic and socio-politic change, giving power to the people (which could be seen as democracy), the form of democracy being iterative in that it is carried out by the one, and affects the whole. The present system (and invention) gives power to the ‘poor’ (or non-wealthy) because, simply by virtue of number, the non-wealthy vastly outnumber the wealthy, thus dispersing vast amounts of money, which creates sociological change. In truth, system does not differentiate between wealthy and unwealthy, rich and poor, and is usable for any user.

The system may be infinitely scalable. Thus there may be, for example, hundreds of thousands of causes synchronised to the system, and configured for dispersement to; there may be billions (or any amount of) users. Preferably the system is configured so that most or all actions are carried out by the system, which may require significant programming.

Referring back to purchase of item 10 as shown in FIG. 6, if the pet cleaning device is purchased by the user with a credit card that has been integrated with the system (and integrated with their user account), the purchase (and purchase information, dispersement information) may appear on their account, as shown in FIG. 9. This opens up several possibilities; for example, it is feasible cause choice is selectable after the purchase is made, so that, for example, a user can log in to their account and decide cause to be dispersed to after they have purchased the item. It is also possible, if the credit card they have paid with is integrated with their account, that they may be messaged immediately after making a purchase, for example, via a smart device, so that user can choose a cause for dispersement.

Message to smart device may be achieved in many ways, such as via phone number. It is also feasible that a message is sent to user via email (which email user may have provided as part of setting up a user account). In such a case, user may be sent an email to a smart device, or may receive (and open) the email via a PC and the like, at which point they may be directed to their account, which may show their purchase(s) and dispersement options.

Thus, a user may log in to their account, view their dispersement options for purchase(s) within their account, and choose cause(s) for dispersement.

If an email address has been provided by the user, there may be provided a ‘LINK’ protocol, whereby a user and cause can be linked via users email address. This may be particularly interesting in a case where a cause has a mission to fulfil so that the cause can inform, and connect with, users who have dispersed to them, (or are configured to disperse to them).

For example, if there are provided options for dispersement causes with respect to purchase of the pet cleaning device not limited only to dog care, but also including animal care (which is logical considering dog lovers tend to be animal lovers), there may be provided a cause which can be dispersed to in order to aid, for example, a project with a mission to build look-out towers in a forest area to deter poachers who are known to poach animals in an area.

In such an example, when a link is set up, user may be provided with information pertaining to mission fulfilment of the cause, such as whether enough liberation amount has been dispersed to the cause to carry out a mission of building four look-out towers. The cause (and those associated with the cause) may be able to film a video (or provided any other information), and send to users via the link. The link need not be provided by way of an email address and may be an integral feature of the account system, whereby information can be sent to users who have an account. LINK protocol may be established with any form/method of communication.

Thus significant information may be made available to a user about a cause after a purchase has been made, and it can be seen that cause choice can be made after a purchase.

In such a case where there is a provided a choice of causes for a user to choose from purchase of an item(s), the selling system is said to be using an ‘OPEN’ configuration. In a case where cause choice is not provided, and the cause(s) are pre-determined, the system is said to be using an ‘AUTO’ configuration.

However, as aforementioned, it is also possible, if there is provided an account for a user, that settings can be configured by the user, preferably from within the account of the user. Some users may not want a particularly interactive experience, whereby choices constantly need to be made. Such users may want to set their account to ‘AUTO’, which automates, or substantially automates, dispersement decisions. Thus items can be purchased and dispersements are sent to pre-determined (or intelligently systematically determined) causes.

There may also be provided an ‘OPEN’ configuration option, whereby user can set their account to a most interactive experience, whereby choices are required for choosing causes for dispersement etc.

Options may also be provided whereby, for example, user can define whether ‘LINK’ protocol options are provided to the user—thus such options may be turned on and off by a user.

In a case where an item, such as the item as shown in FIG. 6 is provided, which incorporates a choice of possible causes to disperse to, if a user has set account settings to ‘AUTO’, such a choice may not occur. Thus it would be desirable if either:
1) seller or brand manufacturer of item or any other entity has apportioned an ‘AUTO-U’ choice for the item for users who have accounts set to ‘AUTO’, so that a cause is chosen by default for a user who has an account set to ‘AUTO’;
2) a random protocol is set up so that one of the causes is randomly chosen for dispersement to, the random protocol preferably substantially evenly dispersing to the causes over time;
3) dispersement amount is evenly distributed to the causes
4) dispersement calculation is carried out intelligently by the system

Thus if AUTO setting has been chosen by the user, preferably via their account settings, choice options may be by-passed by the user.

Significant limitations, regulations etc may be provided by the system and/or provider of the system. The system is founded upon a new system of selling that incorporates dispersement to a cause(s), information and settings preferably relayed to user. Preferably sellers can set parameters for dispersement, and choose cause(s) for dispersement etc. It is also feasibly significant automatic features are provided for sellers using the system, so that, for example, they can set cause choice to be decided intelligently by the system. In such a case, system may intelligently decide on relevant (or random) causes for liberation amounts to be dispersed to. For example, system, due to information provided by causes at cause set up page (basic example embodiment FIG. 11) and due to information provided by user, (where user, for example, may have provided information as to where they reside at user set up page) may intelligently provide locally relevant cause choices for where an item is sold. For example, if a purchasable item that liberates a dispersement when purchased is sold in Cambridge, relevant local cause choices may be provided for such items when purchased if seller has set system to decide on cause choice. Similarly, if desired and/or calculated by system, system may put an item on ‘AUTO’ where no choice of cause is given to user when item purchased, if system calculates that the cause is worthy and/or requires dispersement.

Preferably cause(s) are facilitated by the system in setting up causes. Restrictions may apply, Authorization may be required, or may not be.

Preferably the system provides required elements for causes, for as, for example, scannable (and the like) elements, which can be printed for use in posters and the like, or for use on a website and the like. Preferably, the system automates a ‘PUSH and/or LINK’ screen and function for users who require and/or desire such a function.

Setting up a cause may automatically generate a website for a user, which may be useful to achieve more PUSH users, and LINKs.

Preferably the system intelligently disperses dispersements about a community, group and/or area (feasibly not limited in size).

An interesting result of the system is that it may substantially, or wholly immunise a community against recession, since vast quantities of financing is dispersed into the community, even in times of recession. Growth is not particularly important to the system. System generates creation, and is self-sufficient.

For Use On Website

There is shown in FIG. 15, a purchasable item 10 sold online on a website, utilising the present invention. There is shown a dispersement indicator 12, which for the present example, is also a dispersement amount indicator 14, revealing that 25% of profit generating from selling of the item is liberated for dispersement. (Equally a total amount rather than a percentage may be used).

Preferably the website, company, and/or brand that are selling the items are branded in a way that makes it communicatively obvious that the brand disperses money and/or financing and uses the present invention. Thus the website, brand, and/or company, which will herein be described as ‘brand’, and is a seller, may be called a name that heavily suggests or indicates, for example, name of a town, city etc, if it is a brand for dispersing about the said twon, city, etc.

Site is browsed by the user, and may decide they would like to buy an item of clothing. For the sake of the present example, an example is provided where a user wants and/or chooses to buy a baseball cap.

Before landing on a buying page, or a page specific to buying said item, which, in a present example, is a baseball cap 10, there may be provided for a user various media, which may explain and/or showcase a cause or causes which a user may disperse a, preferably percentage of profit, amount of a sale to. Thus there may be provided media such as video, imagery, and information for a user, for example, on a homepage of said website, which may provide information regarding a cause or causes that can be dispersed to, as well as how the invention, functions.

Thus there may be provided on a homepage or any page a ‘sign up’ 146 or ‘log in’ 148 facility so that a user can sign up for a user account. An account may include a payment method not dissimilar to a paypal type payment account and/or system so that a user may, for example, sign in with an email address and a password, and thereby be able to buy an item or items without having to repeatedly pay via a credit card, which may be cumbersome. Alternatively the present invention (system) may incorporate a payment method (such as its own bank system) so that no other payment method is required.

There is shown a cause media button 150, which may be clickable to view a video about cause dispersed to. User can easily sign in and out of using user account, and may be able to change settings of their account in one click on a site (for example between AUTO and OPEN, or any other setting).

There is shown an example in FIG. 16 of the invention being used on a website where a user is signed into their user account, and setting is on OPEN. They are provided with a screen where an item 10 is for sale. Dispersement indicator 12 is shown, which is also here a dispersement amount indicator 14. There is provided a drop down menu 152 for selecting different causes that can be dispersed to when cap is purchased. There is shown a video 154 for a cause, which may provide user with information related to cause and mission to be fulfilled. When cause it altered on dropdown menu 154, different video for different cause may be shown. Thus user is provided with video of each cause, preferably, and may choose which cause to disperse to when purchasing item.

An ‘Add to Cart’ 156 button is shown for purchasing the item.

Once item is purchased, and cause dispersement chosen, there may be provided PUSH and LINK options, etc, which may also feasibly be provided before item 10 has been purchased.

There may be provided social media sharing buttons, etc so that the webpage, item, cause etc can be shared. There may be provided a button (such as social media button) exclusive to the system (provider) so that the item, cause, page, etc can be shared to other users of the system.

There is shown a ‘BACK TO AUTO’ button 158, which allows a user to revert back to AUTO dispersement setting for their account (and therefore user experience) in one click. User may be signed in at all times, for example, sign in may continue after computer is turned off, or may be restarted whenever user starts and uses computer.

If the ‘BACK TO AUTO’ button 158 is pressed, if seller (or any entity with authorisation to do so) has, for example, set selling settings so that purchase of item results in dispersement to only one cause, then the only one cause may be only cause showcased on webpage. Cause selection options may be removed, or greyed out, and ‘BACK TO AUTO’ button may alter to ‘GO OPEN’ button and the like. Thus dispersements (and user experience) settings can be changed dynamically by a user when on a website, not limited to being within user account.

It is feasible, for example, that if a user hovers a cursor over the percentage dispersement amount that they are given further information, such as total dispersement amount, cost price of item, etc, and not limited to such information.

This is an extremely interactive buying experience which adds an added dimension to the buying experience. Furthermore, this can instigate significant change in the outside world, such as building of new buildings, etc.

If a user purchases the item without having an account or signing in, they may not have access to dispersement information, which may only be accessible via a user account. Nevertheless, in such a case, it is feasible a dispersement is nevertheless made to a cause in an automatic (or substantially automatic) manner by the system and/or seller, even if user is not a user. It is also feasible liberation does not occur when item is bought by a user who has not signed up for an account and/or is not signed in. Preferably a dispersement is nevertheless made to a cause.

If user is signed up, and has signed in, they may be provided with PUSH and/or LINK options either before, and more preferably after, a dispersement has been made.

It is feasible signing in is not required in order for data/information to be stored on a user account, if payment system used is integrated with the system, or if payment method used for buying is an incorporated payment method of the system.

User may be able to toggle between different colour items, etc.

It is feasible figures, pricing, may be wholly transparent on the system, so that vast amounts of information are available for users, such as total-cost-price-for-unit calculations by sellers. This may deter sellers from using false calculations, which may be reportable by users. Such information may be mandatory, or not.

It is feasible dispersement amounts may be alterable by a user. In a preferred embodiment, dispersement amounts are not alterable by a user.

Prices of items, despite dispersement, may not significantly, (or at all) rise above standard retail items, especially if the brand, seller, etc is either run substantially non-profit, or is run for a community. It is feasible such a brand, etc may be in part, or wholly, owned by a community.

As aforementioned, settings may be significantly alterable by a user, and not limited to simply AUTO or OPEN setting, but with any amount of optimisation possibilities. Therefore one user may have an extremely interactive experience, with vast amounts of information provided when using the system, whereas another may set to AUTO so they can buy substantially as normal, whilst retaining ability to disperse, and track dispersement information.

Alteration of settings by a user may lead to dynamic alteration of a website selling such items, even if the seller is not the provider. This may require dynamic type coding and integration of the system with the seller website, much of which may be carried out via code and/or coded buttons and the like, which code may be provided to seller for use on seller website.

If user goes to new website, preferably user settings are remembered/unaltered for the new website. Thus if user has a favourite setting, it will be applied globally to any website they land on that uses the present system for selling.

It is feasible there is provided a ‘CHANGE SETTINGS FOR THIS WEBSITE’ whereby a user can set user settings locally for a particular website without altering favourite and/or default user setting. Setting is preferably thus remembered or ‘stored’ for the particular website. This may be done dynamically on a website, or via user account.

The system may integrate with a payment method, such as a Paypal type payment method, or may incorporate one. Information may be required from a user such as name, date of birth, address, etc. It will be obvious that such details may be extremely important for system to optimise experience for a user.

With reference to LINK function, if use has purchased an item (for example a cap) that liberates a dispersement which is dispersed to cleaning of a street, once a milestone (or any new information) has been reached, user may receive a message from the cause, stating, for example: “Thanks user! New £10,000 road cleaner machine purchased!! See it at work!” and there may be provided a link to see the machine in use. One of the primary functions of LINK is for user to see result when a mission, for example, has been fulfilled.

When used in an external environment for selling (not the internet), it will be obvious due to recent technology, that a code and the like is not necessarily required to initiate a communicative connection with a smart device. New technology exists that allows user to hover a smart device over any picture image, etc, and watch as the image alters on their smart device (though not in real life). Therefore it will be obvious to those with skill in the art that, either for PUSH function, where smart device is used to connect with a cause, or for feasible embodiments of a sales purchase using the system whereby user can gain information about a cause, cause dispersement information, etc via use of a smart device, that a scannable element (and the like) may not be required. Nevertheless, if the scannable element prompts a user to take action, and indicates to a user that dispersement can be made (in which case it could be said to be a dispersement indicator), a scanning element may be useful and/or preferred.

A community (if the system is used for dispersement to a community) may be a physical community (such as a town, city, country, etc), or a virtual community (such as a group). An example of a virtual community is dog-owners, who are a group, and are not limited to a physical location.

The system may be used to support cause(s) in great times of distress.

For example users may be allowed and/or requested to PUSH causes, such as an earthquake fund, when a disaster occurs, dispersing vast amounts to help. However, it is feasible such cause(s) may only be allowed if either 1) authorized, or 2) created by the provider. Thus primary function of the system is not affected.

It is feasible causes are not ‘paid’ dispersements, but dispersements are logged in cause account as digital numeration alone, whereby when a mission fulfilment total is reached, finances are released. It is feasible financing is taken care of by the provider and that cause never receives dispersement money. Thus, for example, provider may release accrued dispersement amount to a company to buy a street cleaning machine, cause never receiving the money, but receiving the street cleaning machine that was bought with money accrued by dispersements to the cause.

Safety features may be implemented to stop causes accessing dispersements amounts, such that dispersement to the cause is not accessible and/or may not be convertible into real money by the cause. Such safety procedures may, or may not be temporary.

There may be provided significant safety procedures to make sure that dispersement money dispersed to a cause is not simply withdrawn by the cause and not used for causes stated intended purpose, or is simply withdrawn for personal use. This may include legal agreements, and systematic procedures, etc.

The system may, feasibly, use cookies, etc and other data to intelligently optimise user experience and show user new causes that may be similar to causes user has dispersed to. Such features may feasibly be optional, so that they can be turned off by a user. Thus if a user has dispersed to dog causes, system may intelligently display, or provide choice with regard to, causes that are intended to help animals, and the like.

A cause may, for example, be an entrepreneur who wishes to start up a company.

It is feasible that a small fee is exerted from the seller, cause, etc, for using the system, or simply that a very small fee from dispersements is retained by the provider.

If a smart device is used by a user to gain dispersement information, for example, showing a dispersement amount for an item 10, the smart device may be said to be a dispersement indicator 12, and may be a dispersement amount indicator 14. If it provides dispersement cause information, it may be a dispersement cause indicator 16.

The embodiments described above are provided by way of example only, and various other modifications will be apparent to persons skilled in the art without departing from the scope of the invention as described in the appended claims.

1. A system for selling, comprising:
allowing an item to be purchased by a user;
providing a dispersement indicator to indicate to the user that purchase of the item liberates a dispersement amount for dispersement to at least one cause;
dispersing the dispersement amount to the at least one cause.

2. A system for selling as claimed in claim 1, wherein there is provided an interlocuting element to facilitate at least one of:
relaying information to a user account;
relaying information so that dispersement is dispersed to the at least one cause.

3. A system for selling as claimed in claim 1, wherein there is provided a dispersement amount indicator.

4. A system for selling as claimed in claim 3, wherein there is provided a dispersement cause indicator.

5. A system for selling as claimed in claim 1, wherein at least one of:
bank details;
information to facilitate dispersing of a dispersement into an account,
is received from the at least one cause and stored, thus facilitating dispersement to the at least one cause.

6. A system for selling as claimed in claim 1, wherein there is provided a user account, dispersement information relayed to the user account.

7. A system for selling as claimed in claim 6, wherein cause choice is choosable by the user post-purchase via the user account.

8. A system for selling as claimed in claim 6, wherein dispersement settings are adjustable by the user.

9. A system for selling as claimed in claim 6, wherein the user account is password protected.

10. A system for selling as claimed in claim 6, wherein there is provided a PUSH protocol, so that a cause is pushable by a user, dispersement settings biased to disperse to the pushed cause.

11. A system for selling as claimed in claim 6, wherein there is provided a LINK protocol, whereby a user can choose to link with a cause that has been dispersed to.

12. A system for selling, comprising:
allowing a user to purchase an item;
allowing a plurality of causes to be associated with the item, so that when the item is purchased by the user, a dispersement amount is dispersable to at least one of the causes;
providing cause choice for the user,
wherein cause choice for the user is choosable at least one of:
before purchase via a smart device;
substantially during purchase;
after purchase via a user account.

13. A system for selling as claimed in claim 12, wherein causes for dispersement are chosen and associated with the item by seller of the item, seller of the item being at least one of:
manufacturer of the item;
vendor of the item.

14. A system for selling as claimed in claim 13, wherein cause choice is decidable and associatable with the item by the seller via a seller account, seller account incorporated as part of the system.

15. A system for selling as claimed in claim 12, wherein cause creation is incorporated by the system, a cause creatable within the system by an entity so that the dispersement amount is dispersable to the cause.

16. A system for selling as claimed in claim 12, wherein user settings are alterable for the user so that cause choice is by-passable for the user by altering user settings.

17. A system for financing, comprising:
allowing an entity to create a cause;
allowing the entity to display a dispersement indicator;
allowing a user to connect with the cause via smart device;
providing a PUSH protocol so that the cause can be pushed by the user;
altering settings of the user so that the cause is pushed by the user,
settings thus altered to bias user dispersement to the cause.

18. A system for financing as claimed in claim 17, wherein there is provided a scannable element for connecting to the cause via smart device.

19. A system for financing as claimed in claim 18, wherein the scannable element is generated by the system, and usable by the cause for connecting with user.

20. A system for financing as claimed in claim 17, wherein there is provided a LINK protocol to facilitate contact between cause and user.

21. A system for financing as claimed in claim 20, wherein altering settings of the user and LINK protocol is carried out via an account, user account provided for the user.

22. A system for financing as claimed in claim 17, further comprising receiving bank details of the cause to facilitate receipt of dispersement from user by the cause.
